(19) United States
(12) Patent Application Publication
(10) Pub. No.: US 2006/0040822 A1
(43) Pub. Date: Feb. 23, 2006

(54) Catalyst compositions, processes, and products utilizing pillared clays

(76) Inventors: Joseph S. Shveima, Bartlesville, OK (US); Shirley J. Martin, Bartlesville, OK (US); Nancy W. Eilerts, Kingwood, TX (US); Lloyd W. Guatney, Bartlesville, OK (US)

Correspondence Address: WOMBLE CARLYLE SANDRIDGE & RICE, PPLC;CHEVRON PHILLIPS CHEMICAL COMPANY LP, P.O. BOX 7037, ATLANTA, GA, 30357-0037, US

(21) Appl. No.: 10/924,366

(22) Filed: Aug. 23, 2004

(51) Int. Cl. C08F 4/06; B01J 31/00

(52) U.S. Cl. 502/103; 526/172; 526/905; 502/150; 502/118

(57) ABSTRACT

The present invention provides new catalyst compositions, methods of preparing a catalyst composition, and methods for polymerizing ethylene and other olefins. In one aspect, a catalyst composition comprising an ion-exchangable support such as a pillared clay; a transition metal compound in which the metal has a dⁿ electron configuration, wherein n is greater than or equal to 4 and less than or equal to 8; and an organometal cocatalyst is disclosed.

### TECHNICAL FIELD OF THE INVENTION

This invention relates to the field of olefin polymerization catalyst compositions, and methods for the polymerization and copolymerization of olefins, particularly using a supported catalyst composition.

### BACKGROUND OF THE INVENTION

It is known that mono-1-olefins (α-olefins), including ethylene, can be polymerized with catalyst compositions employing titanium, zirconium, vanadium, chromium or other metals impregnated on a variety of porous support materials. These catalyst compositions can be useful for both homopolymerization of ethylene, as well as copolymerization of ethylene with comonomers such as propylene, 1-butene, 1-hexene, or other higher α-olefins. As such, there exists a constant search to develop new olefin polymerization catalysts, catalyst activation processes, and methods of making and using catalysts, that will provide polymeric materials tailored to specific end uses.

Heterogeneous catalysts such as alumina- or silica-supported transition metal catalysts, such as titanium, zirconium, vanadium, chromium, and others, have been used in the production of polyethylene. One consideration in designing and operating heterogeneous polymerization catalyst compositions is the role the catalyst support can play in determining the polymerization conditions and the resulting polymer properties. Although the support material in a heterogeneous catalyst composition is an insoluble component, the support can substantially influence the reactivity at the active catalytic sites, because of its chemical interaction with those sites. Therefore, considerations toward influencing polymer properties through catalyst design must take into account the transition metals, any cocatalysts, and any support material or combination of support materials employed.

What is needed are new catalyst compositions that will allow polymer properties to be adjusted or maintained within certain product specification ranges. What is also needed are new catalyst-cocatalyst-support combinations that provide catalyst compositions of the desired activity.

### SUMMARY OF THE INVENTION

This invention comprises catalyst compositions, methods for preparing catalyst compositions, methods for polymerizing olefins using the catalyst compositions, polyolefins, and articles made from such polymers. It has been discovered that highly active catalyst compositions could be produced by combining a catalyst and cocatalyst with an activator-support such as a pillared clay. In one aspect, the catalyst composition of this invention comprises at least one transition metal compound in which the metal has a dⁿ electron configuration, wherein n is greater than or equal to 4 and less than or equal to 8, at least one pillared clay, and at least one cocatalyst, that provide catalysts of sufficiently high activity to be commercially viable. The catalyst compositions of this invention can be used for homopolymerization of an α-olefin monomer, and for copolymerization of an α-olefin with a comonomer.

In one aspect, the transition metal compound used in the catalyst compositions of this invention comprises a transition metal having a d^{4≦n≦8} electron configuration. In another aspect, for example, the transition metal can be Cr, Mo, W, Mn, Re, Fe, Ru, Os, Co, Rh, Ir, Ni, Pd, or Pt. In yet another aspect, the transition metal can be Cr, Mn, Fe, Co, or Ni.

One method for adjusting the activity of the catalyst of this invention is by modifying the ligands coordinated to the transition metal in the transition metal compound used to prepare the catalyst composition. In one aspect of the invention, the transition metal compound comprises at least one ligand comprising an oxide, halide, nitride, ammonia, amine, amide, imide, carboxylate, acetylacetonate, dithiolate, carbonyl, cyanide, isocyanide, nitrile, peroxide, hydroxide, hydride, ether, diether, triether, carbonate, phosphate, nitrate, nitrite, sulfate, alkoxide, siloxide, thiolate, dithiolate disulfide, carbamate, dialkylcarbamate, pyridine, bipyridine, phenanthroline, terpyridine, diamine, triamine, diimine, pyridine diimine, pyrazolylborate, bis(pyrazolyl)borate, tris(pyrazolyl)borate, nitrosyl, thiocarbamate, diazabutadiene, dithiocarbamate, dialkylacetamide, dialkylformamide, formamidinate, phosphine, arsine, diphosphine, diarsine, oxalate, imidazole, pyrazolate, Schiff base, porphyrin, phthalocyanine, subphthalocyanine, picolinate, piperidine, pyrazolyl, salicylaldehyde, ethylenediamine, triflate, η²-alkene, η²-alkyne, η³-allyl, η⁴-diene, η⁵-pentadienyl, η⁶-arene, η⁷-heptatrienyl, η⁷-cycloheptatrienyl, η⁸-octatetraene, a substituted analog thereof, or a combination thereof, any one of which having up to about 20 carbon atoms.

In another aspect, the transition metal compound employed in this invention can be a coordination compound of iron or nickel, containing monodentate or chelating ligands, or combinations thereof. Examples of typical ligands include, but are not limited to, halide, alkoxide, amide, imide, amine, diamine, terdentate pyridine diimine, acetylacetonate, carboxylate ligands, or combinations thereof. In one aspect, the transition metal coordination compounds employed in this invention can be 2,6-bis[1-(2,6-diisopropylphenylimino)ethyl]pyridine-bis(hexafluoroacetylacetonate) metal complexes, that is, compounds of the formula {2,6-[(2,6-i-Pr₂C₆H₃)N═CMe]₂C₅H₃N}M(η²-OCCF₃CHCCF₃O)₂, where M is Ni or Fe.

In one aspect, the catalyst composition of this invention comprises a support or “activator-support” component, typically an ion-exchangeable support component. In another aspect, this support component includes, but is not limited to, silicate and aluminosilicate compounds or minerals, either with layered or non-layered structures, including combinations thereof. While not intending to be bound by theory, it is believed that the ion-exchangeable support component functions not simply as an inert support, but is involved in the catalytic chemistry. Accordingly, the support component can be referred to as an activator-support, a cocatalyst-support, or by similar terms.

In yet another aspect, ion-exchangeable, layered aluminosilicates such as pillared clays can be used as the support component. Suitable clay minerals for pillaring that are useful in the catalyst composition of this invention include, but are not limited to: allophanes; smectites, both dioctahedral (Al) and tri-octahedral (Mg) and derivatives thereof such as montmorillonites (bentonites), nontronites, hectorites, or laponites; halloysites; vermiculites; micas; fluoromicas; chlorites; mixed-layer clays; the fibrous clays including but not limited to sepiolites, attapulgites, and polygorskites; a serpentine clay; illite; laponite; saponite; or combinations thereof. In another aspect, the pillared clay support can comprise bentonite or montmorillonite.

The catalyst compositions of this invention also comprise an organometal cocatalyst. In one aspect, the organometal cocatalyst comprises an organoaluminum compound, an aluminoxane, an organoboron compound, an organozinc compound, or any combination thereof.

In one aspect, the organometal cocatalyst comprises an organoaluminum compound having the following formula:
Al(X⁵)ₙ(X⁶)₃₋ₙ,
wherein (X⁵) is a hydrocarbyl or substituted hydrocarbyl having from 1 to about 20 carbon atoms; (X⁶) is alkoxide or aryloxide, any one of which having from 1 to about 20 carbon atoms, halide, or hydride; and n is a number from 1 to 3, inclusive. In another aspect, the cocatalyst of this invention can comprise organoaluminoxanes, including, but not limited to, organoaluminoxanes represented generally by formulas such as (R—Al—O)ₙ, R(R—Al—O)ₙAlR₂, and the like, wherein the R group is typically a linear or branched C₁-C₆ alkyl such as methyl, ethyl, propyl, butyl, pentyl, or hexyl wherein n typically represents an integer from 1 to about 50.

In another aspect, the organometal cocatalyst of this invention comprises an organoboron compound having the following formula:
B(X⁵)ₙ(X⁶)₃₋ₙ,
wherein (X⁵) is independently a hydrocarbyl or substituted hydrocarbyl having from 1 to about 20 carbon atoms; (X⁶) is alkoxide or aryloxide, any one of which having from 1 to about 20 carbon atoms, halide, or hydride; and n is a number from 1 to 3, inclusive.

In still another aspect, the organometal cocatalyst comprises an organozinc compound having the following formula:
Zn(X⁵)(X⁶);
wherein (X⁵) is a hydrocarbyl or substituted hydrocarbyl having from 1 to about 20 carbon atoms; (X⁶) is a hydrocarbyl, an alkoxide or an aryloxide having from 1 to about 20 carbon atoms, halide, or hydride.

Yet another aspect of this invention is a catalyst composition comprising a combination of more than one organometal cocatalyst, for example a combination of an organoaluminum and an aluminoxane cocatalyst.

The present invention also comprises new methods for preparing catalyst compositions, comprising contacting a transition metal compound, an ion-exchangeable support such as a pillared clay, an organometal cocatalyst such as an organoaluminum compound, and optionally hydrogen gas. Thus, one aspect of this invention is increasing the catalytic activity of the polymerization catalysts disclosed herein by using hydrogen gas.

In still another aspect, the catalyst composition further comprises an optional ionizing ionic compound, wherein the ionizing ionic compound can be a borate compound, an aluminate compound, or a combination thereof.

In another aspect, for example, the catalyst composition of this invention comprises the contact product of a bentonite pillared clay which is employed as an ion-exchangeable support, a transition metal compound of iron or nickel of the formula {2,6-[(2,6-i-Pr₂C₆H₃)N═CMe]₂C₅H₃N}M(η²-OCCF₃CHCCF₃O)₂, wherein M is Ni or Fe, and trimethylaluminum (TMA) as a cocatalyst, in which ethylene is polymerized in the presence of hydrogen gas. This catalyst composition provides a highly active catalyst for olefin polymerization and copolymerization.

Polymerization reactions using the catalyst compositions of this invention can be carried out in the presence or absence of hydrogen. In one aspect, the presence of hydrogen typically enhances the polymerization activity of the catalyst composition of this invention.

In another aspect of this invention, the activity of a catalyst prepared with an ion-exchangeable support component, typically a pillared clay, and trimethylaluminum (TMA), according to this invention is greater than the catalyst prepared with either supported methylaluminoxane (MAO) or solution MAO in the presence of TMA, or any other cocatalyst/support system examined. Further, the use of a pillared clay as support and cocatalyst for olefin polymerization is much more economical than the MAO/silica system which is currently one of the cocatalyst/support systems of choice.

In yet another aspect of this invention, the polymer that is typically provided with the catalysts of this invention is a low-density, highly-branched polyethylene, as typically produced in a loop process or solution polymerization process, although other polymerization methods are applicable to the catalyst of this invention.

These and other features, aspects and advantages of the present invention will become apparent after a review of the following detailed description of the disclosed embodiments.

### DEFINITIONS

In order to more clearly define the terms used herein, the following definitions are provided. To the extent that any definition or usage provided by any document incorporated herein by reference conflicts with the definition or usage provided herein, the definition or usage provided herein controls.

The terms “polyethylene” and “ethylene polymer” are used herein to refer to both homopolymers comprising ethylene and copolymers of ethylene and another olefinic comonomer, as the context allows.

The terms “catalyst composition,” “catalyst mixture,” and sometimes simply “catalyst” are used herein to refer to compositions comprising a transition metal compound, an organometal cocatalyst, and a ion-exchangeable support that can be prepared according to the present invention. The use of these terms does not depend upon the actual product of the reaction of these components, the nature of the active catalytic site, or the fate of the transition metal compound, the cocatalyst, or the ion-exchangeable support after combining these components. In some contexts, the transition metal compound alone can be referred to simply as the “catalyst”, in much the same way the term “cocatalyst” can be used herein to refer to, for example, an organoaluminum compound.

The dⁿ electron configuration designation has its usual meaning for transition metal complexes and is determined according to the normal rules for doing so. Thus, the number n represents the total number of xd, (x+1)s, and (x+1)p valence electrons of a transition metal in a compound, where x is 3 for first row transition metals, x is 4 for second row transition metals, and x is 5 for third row transition metals. Thus, for transition metal complexes, the xd, (x+1)s, and (x+1)p orbitals are all considered normal valence orbitals. For example, any complex of Fe(II), such as (N³py) Fe(hfacac)₂ is a d⁶ complex. The term “hydrocarbyl” is used to specify a hydrocarbon radical group that includes, but is not limited to aryl, alkyl, cycloalkyl, alkenyl, cycloalkenyl, cycloalkadienyl, alkynyl, aralkyl, aralkenyl, aralkynyl, and the like, and includes all substituted, unsubstituted, branched, linear, heteroatom substituted derivatives thereof. In one aspect, hydrocarbyl groups of the present invention have from 1 to about 30 carbon atoms. In yet another aspect, hydrocarbyl groups of the present invention have from 1 to about 20 carbon atoms. In still another aspect, hydrocarbyl groups of the present invention have from 1 to about 10 carbon atoms.

The terms “cocatalyst” and “activating cocatalyst” are used herein to refer to the organometal component of the present invention, which is typically organoaluminum compounds, aluminoxanes, organoboron compounds, or organozinc compounds, or any combination thereof. The term cocatalyst can also be used to describe the optional catalyst components hydrogen, and an ionizing ionic compound, as disclosed herein. Thus, cocatalyst is generally used herein to refer to the organometal compounds that can constitute one component of the catalyst composition, but also refers to the optional components of the catalyst composition including, but not limited to, hydrogen, an ionizing ionic compound, or a combination thereof as disclosed herein. These terms are used without being limited by the actual function of the compound or any chemical mechanism by which the compound can operate.

The terms “support” or “activator-support” are used herein to indicate an insoluble component of the heterogeneous catalyst and catalytic process of the present invention that is used to produce polyolefin, and with which the transition metal compound and organometal compound are reacted to form the active catalyst. The term “support” is not used to imply this component is inert, and should not be construed as an inert component of the catalyst composition. This term is used to refer to more traditional inorganic oxide materials, as well as non-oxide materials and mixtures thereof. The typical support of this invention is an ion-exchangeable support such as an aluminosilicate clay.

The term “clay” is used herein to refer to that component of the catalyst composition, a substantial portion of which constitutes a clay mineral or a mixture of clay minerals that have been pretreated by either exchanging cations, pillaring or simply wetting, that is used as a support in the catalyst composition described herein. The transition metal compound and organometal cocatalyst are contacted with the clay support to form the active catalyst. While not intending to be bound by theory, the clay component of the catalyst composition of this invention is believed to function as both a support for the transition metal compound, as well as a cocatalyst. Again, while not intending to be bound by theory, the dual acidic nature of the clay component, having both Brönsted and Lewis acidic sites, can allow the clay to react with the transition metal compound as a prelude to its activation for polymerization.

As used herein, the collective term “clay mineral” is used herein to describe the large group of finely-crystalline, sheet like clay minerals that are found in nature in fine-grained sediments, sedimentary rocks, and the like. Clay minerals are a class of hydrous silicate and aluminosilicate minerals with sheet-like structures and very high surface areas. This term is also used to describe hydrous magnesium silicates with a phyllosilicate structure. Many common clay minerals belong to the kaolinite, montmorillonite, or illite groups of clays. Thus, the term “clay mineral” is not used herein to refer to the fine-grained soil consisting of mineral particles, not necessarily clay minerals, that are less than about 0.002 mm in size.

The term “pillared clay” is used herein to refer to a component of the catalyst composition comprising clay minerals, typically of the smectite group and other phylosilicates in addition to sepiolites and palygorskites, that have been ion exchanged with large, typically polynuclear, highly charged metal complex cations. Examples of such ions include, but are not limited to, Keggin ions which can have charges such as 7+, various polyoxometallates of any number of metal ions, including, but not limited to Ti, Fe and Cr, as well as other large ions. Thus, the term pillaring refers to a simple exchange reaction in which the exchangeable cations of a clay material are replaced with large, highly charged ions, such as Keggin ions. These polymeric cations are then immobilized within the interlayers of the clay and when calcined are converted to metal oxide “pillars,” effectively supporting the clay layers as column-like structures. Examples of pillaring and pillared clays are found in: T. J. Pinnavaia, Science 220 (4595), 365-371 (1983); J. M. Thomas, Intercalation Chemistry, (S. Whittington and A. Jacobson, eds.) Ch. 3, pp. 55-99, Academic Press, Inc., (1972); U.S. Pat. No. 4,452,910; U.S. Pat. No. 5,376,611; and U.S. Pat. No. 4,060,480; each of which is incorporated herein in its entirety.

“Bentonite” is the colloidal, hydrated aluminum silicate clay material that consists primarily of montmorillonite, that has the approximate formula (Na,Ca,H)(Al,Mg,Fe,Li)₂(Si,Al)₄O₁₀(OH)₂●xH₂O Bentonite is characterized by its high cation exchange capacity, absorptivity and colloidal nature.

The term “inert atmosphere” is used herein to refer to any type of ambient atmosphere that is substantially unreactive toward the particular reaction, process, or material around which the atmosphere surrounds or blankets. Thus, this term is used to refer to the use of a substantially oxygen-free and moisture-free blanketing gas, including but not limited to dry argon, dry nitrogen, dry helium, or mixtures thereof, when any precursor, component, intermediate, or product of a reaction or process is sensitive to particular gases or moisture. Additionally, “inert atmosphere” is also used herein to refer to the use of dry air as a blanketing atmosphere when the precursors, components, intermediates, or products of the reaction or process are only moisture-sensitive and not oxygen-sensitive.

As used herein, the terdentate pyridine diimine ligand 2,6-[(2,6-i-Pr₂C₆H₃)N═CMe]₂ is abbreviated N₃py, and the hexafluoroacetylacetonate ligand is abbreviated hfacac. One embodiment of this invention provides for a nickel or iron catalyst of the formula {2,6-[(2,6-i-Pr₂C₆H₃)N═CMe]₂C₅H₃N}M(η²-OCCF₃CHCCF₃O)₂, where M is Ni or Fe, and thus which are indicated as Ni(N₃py)(hfacac)₂ and Fe(N₃py)(hfacac)₂, respectively.

### DETAILED DESCRIPTION OF THE INVENTION

The present invention provides new compositions comprising catalyst, cocatalyst, and support wherein the catalyst comprises a transition metal compound, the support comprises an ion-exchangeable support, and the cocatalyst comprises an organometal compound. Hydrogen is an optional component of the catalyst composition. Ionizing ionic compounds are also optional components. This invention further provides new methods to prepare and use the new catalysts for ethylene polymerization and copolymerization. The polyolefins produced according to this invention, and the articles made from such polymers, constitute other aspects of this invention.

Catalyst Compositions and Components

In one aspect, this invention provides a catalyst composition comprising: a) a transition metal compound in which the transition metal has a dⁿ electron configuration, wherein n is greater than or equal to 4 and less than or equal to 8; b) a pillared clay; and c) an organometal cocatalyst. In another aspect, hydrogen is an optional component of the catalyst composition. This invention also comprises methods for preparing catalyst compositions, and methods for polymerizing olefins using the catalyst compositions.

The Transition Metal Compound

In one aspect, the catalyst composition of this invention comprises a transition metal compound, which itself comprises a d^{4≦n≦8} transition metal compound, that is, a transition metal compound in which the metal has a dⁿ electron configuration, wherein n is greater than or equal to 4 and less than or equal to 8. Thus, the transition metal compound of this invention can comprise a metal of the d⁴, d⁵, d⁶, d⁷, or d⁸, electron configuration. The d^{4≦n≦8} transition metal compounds include, but are not limited to compounds comprising Cr, Mo, W, Mn, Re, Fe, Ru, Os, Co, Rh, Ir, Ni, Pd, or Pt. In one aspect, the d^{4≦n≦8} transition metal compound can comprise a first row transition metal such as Cr, Mn, Fe, Co, or Ni. In another aspect, the transition metal compound of this invention comprises a metal of the d⁶, d⁷, or d⁸ electron configuration. In still another aspect, the transition metal compound comprises a metal of the d⁶ or d⁸ election configuration.

Transition metal compounds that comprise a metal in the d⁴ electron configuration include, but are not limited to, compounds that comprise Cr(II), Mo(II), W(II), Mn(III), Re(III), Fe(IV), Ru(IV), Os(IV), Co(V), Rh(V), or Ir(V).

Transition metal compounds that comprise a metal in the d⁵ electron configuration include, but are not limited to, compounds that comprise Cr(I), Mo(I), W(I), Mn(II), Re(II), Fe(III), Ru(III), Os(III), Co(IV), Rh(IV), Ir(IV), Pd(V), or Pt(V).

Transition metal compounds that comprise a metal in the d⁶ electron configuration include, but are not limited to, compounds that comprise Cr(0), Mo(0), W(0), Mn(I), Re(I), Fe(II), Ru(II), Os(II), Co(III), Rh(III), Ir(III), Ni(IV), Pd(IV), or Pt(IV).

Transition metal compounds that comprise a metal in the d⁷ electron configuration include, but are not limited to, compounds that comprise Mn(0), Re(0), Fe(I), Ru(I), Os(I), Co(II), Rh(II), Ir(II), Ni(III), Pd(III), or Pt(III).

Transition metal compounds that comprise a metal in the d⁸ electron configuration include, but are not limited to, compounds that comprise Fe(0), Ru(0), Os(0), Co(I), Rh(I), Ir(I), Ni(II), Pd(II), or Pt(II).

In one aspect, the d^{4≦n≦8} transition metal compounds used in the catalyst compositions of this invention are coordinated by ligands with coordinating or donor atoms comprising at least one fluorine, chlorine, bromine, iodine, oxygen, sulfur, selenium, nitrogen, phosphorus, arsenic, carbon, silicon, germanium, or tin atom, or any combination thereof. The d^{4≦n≦8} transition metal compounds encompassed by this invention can also comprise anionic or cationic complexes, in addition to neutral compounds, and therefore can be used as salts. For purposes of the invention, any counterion can be used to form the salt of an anionic or cationic metal complex, such that it provides the necessary solubility and stability to the compound.

In one aspect, suitable ligands for the transition metal compounds of this invention include, but are not limited to, oxide, halide, nitride, ammonia, amine, amide, imide, carboxylate, acetylacetonate, dithiolate, carbonyl, cyanide, isocyanide, nitrile, peroxide, hydroxide, hydride, ether, diether, triether, carbonate, phosphate, nitrate, nitrite, sulfate, alkoxide, siloxide, thiolate, dithiolate disulfide, carbamate, dialkylcarbamate, pyridine, bipyridine, phenanthroline, terpyridine, diamine, triamine, diimine, pyridine diimine, pyrazolylborate, bis(pyrazolyl)borate, tris(pyrazolyl)borate, nitrosyl, thiocarbamate, diazabutadiene, dithiocarbamate, dialkylacetamide, dialkylformamide, formamidinate, phosphine, arsine, diphosphine, diarsine, oxalate, imidazole, pyrazolate, Schiff base, porphyrin, phthalocyanine, subphthalocyanine, picolinate, piperidine, pyrazolyl, salicylaldehyde, ethylenediamine, triflate, and other common ligands known in coordination chemistry, including substituted analogs thereof, and combinations of these ligands, any one of which having up to about 20 carbon atoms.

In another aspect of this invention, any combination of monodentate, bidentate, tridentate, or tetradentate ligands, or ligands that occupy even more coordination sites, can be used in this invention. In yet another aspect, transition metal complexes of this invention that contain polydentate ligands can comprise one or two labile, usually monodentate, ligands in addition to a polydentate ligand. In another aspect, transition metal complexes of this invention that contain polydentate ligands can comprise two labile ligands as well. While not intending to be bound by the following statement, it is believed that the lability of these ligands aids in providing a coordination site for the growing polymer chain. Further, it is believed that the polymerization works well when the olefin monomer has access to the metal center, typically with the availability of its own coordination site.

This invention further encompasses the use of ligands similar to those provided herein, with respect to ligand donor atoms, structural motifs, ring sizes, and the like. The transition metal compounds can also comprise organometallic compounds, coordinated by ηⁿ-carbon ligands, wherein n can take on values ranging from 1 to about 8. For example, the catalyst composition can comprise d^{4≦n≦8} transition metal compounds comprising η²-alkene, η²-alkyne, η³-allyl, η⁴-diene, η⁵-pentadienyl, η⁵-cyclopentadienyl, η⁷-heptatrienyl, η⁷-cycloheptatrienyl, η⁸-octatetraene ligands, or substituted analogs thereof, and the like, any one of which having up to about 20 carbon atoms.

In one aspect, the ligands on the transition metal compound of this invention can comprise chelating ligands comprising at least one oxygen, sulfur, nitrogen, phosphorus, or arsenic donor atom. Examples of such ligands include, but are not limited to, carboxylate, acetylacetonate, dithiolate, carbamate, bipyridine, phenanthroline, terpyridine, diamine, triamine, diimine, pyridine diimine, thiocarbamate, dithiocarbamate, diphosphine, diarsine, oxalate, bis(pyrazolyl)borate, tris(pyrazolyl)borate, thiocarbamate, diazabutadiene, dithiocarbamate, Schiff base, porphyrin, phthalocyanine, subphthalocyanine, ethylenediamine, substituted analogs thereof, any combination thereof, and the like, any one of which having up to about 20 carbon atoms.

In another aspect, diimine and related ligands can be used as ligands on the transition metal complex which is then used in preparing the catalyst composition of this invention. In this aspect, the transition metal compound can comprise at least one ligand having the formula: 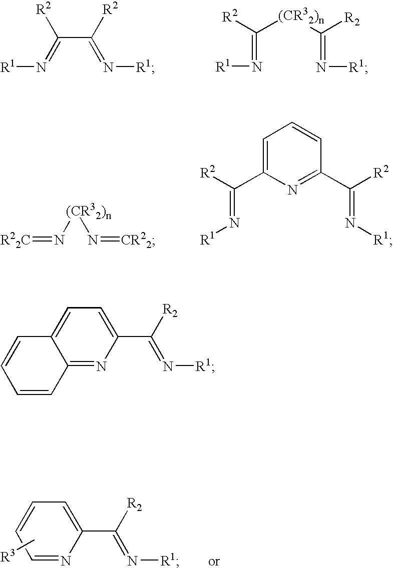
any combination thereof; wherein R¹, R², and R³ are, in each instance, independently a hydrocarbyl or a substituted hydrocarbyl having from 1 to about 20 carbon atoms; H; or halide; and wherein n is from 1 to about 5.

In another aspect, the transition metal compound used in the catalyst composition of this invention comprises at least one ligand having the formula: 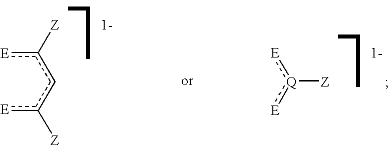
wherein E is independently O, S, NR, or CR₂; Q is independently C or S; and Z is independently OR, SR, NR₂, PR₂, R, SiR₃, or halide; wherein R in each instance is independently a hydrocarbyl or a substituted hydrocarbyl having from 1 to about 20 carbon atoms, or hydrogen.

In still another aspect, the transition metal compound used in the catalyst composition of this invention comprises a ligand with the following formula: 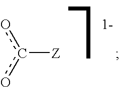
Z is independently OR, SR, NR₂, PR₂, R, SiR₃, or halide; wherein R in each instance is independently a hydrocarbyl or a substituted hydrocarbyl having from 1 to about 20 carbon atoms, or hydrogen.

In still another aspect, the transition metal compound used in the catalyst composition of this invention comprises at least one ligand having the formula: 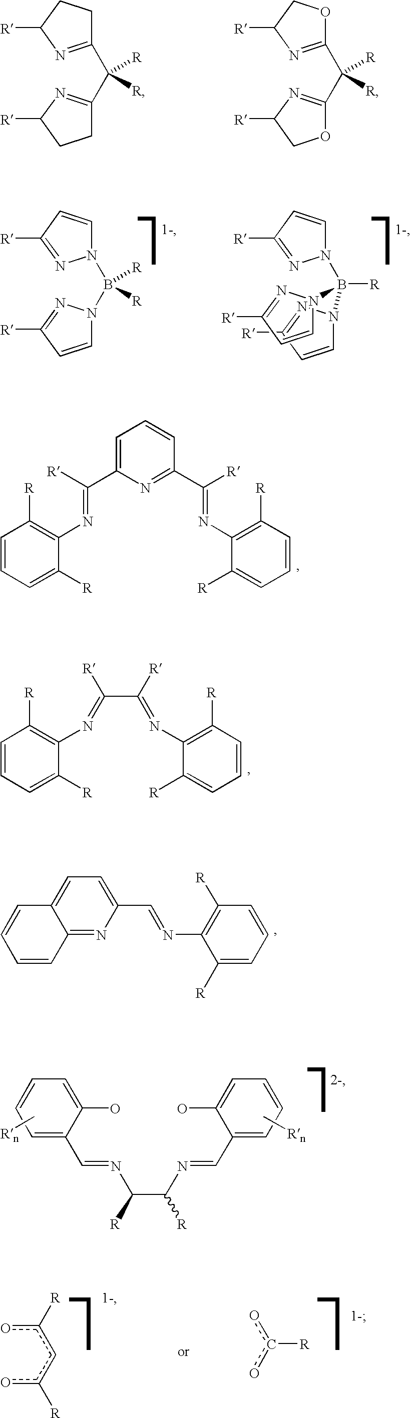
wherein R and R′ are independently aryl, alkyl, cycloalkyl, alkenyl, cycloalkenyl, cycloalkadienyl, alkynyl, aralkyl, aralkenyl, or aralkynyl, or a substituted derivative thereof, any one of which having from 1 to about 20 carbon atoms; halide; or hydrogen.

Thus, another aspect of this invention is the use of cyclic diimine ligands for the transition metal. For example, cyclic diimine ligands can include, but are not limited to, the structures shown in Ia and Ib herein, wherein R and R′ independently comprise a hydrocarbyl group including, but not limited to, aryl, alkyl, cycloalkyl, alkenyl, cycloalkenyl, cycloalkadienyl, alkynyl, aralkyl, aralkenyl, or aralkynyl, and the like, including all substituted, unsubstituted, branched, linear, heteroatom substituted, and halogen substituted derivatives thereof, any one of which having from 1 to about 20 carbon atoms; halide; or hydrogen.

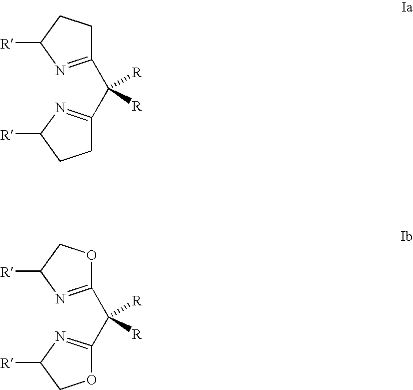

Ligands similar to the cyclic. imine derivatives shown can also be employed in this invention, for example the pyrazolyl-based ligands, including but not limited to the anionic bis(pyrazolyl)borate ligands or tris(pyrazolyl)borate ligands, can be used as ligands for the transition metal compound of this invention. The structures of exemplary bis(pyrazolyl)borate and tris(pyrazolyl)borate ligands are shown as Ia and IIb respectively, wherein R and R′ independently comprise a hydrocarbyl group including, but not limited to, aryl, alkyl, cycloalkyl, alkenyl, cycloalkenyl, cycloalkadienyl, alkynyl, aralkyl, aralkenyl, or aralkynyl, and the like, including all substituted, unsubstituted, branched, linear, heteroatom substituted, and halogen substituted derivatives thereof, any one of which having from 1 to about 20 carbon atoms; halide; or hydrogen. In one aspect of this invention, for the tris(pyrazolyl)borate ligands shown in IIb, R′ is typically smaller than t-butyl.

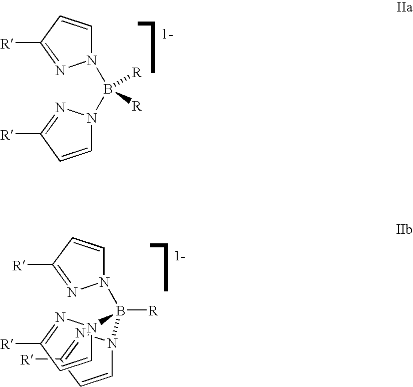

Another aspect of this invention provides for a transition metal compound comprising a terdentate pyridine diimine ligand. The pyridine diimine ligand is a neutral ligand which, by virtue of the diimine substitutions bonded in the 2- and 6-positions on the pyridine ring, functions to bind the metal center in a terdentate (also called tridentate) bonding mode. This terdentate pyridine diimine ligand has the structure 2,6-(RN═CR′)₂C₅H₃N, wherein R and R′ are independently a hydrocarbyl group including, but not limited to, aryl, alkyl, cycloalkyl, alkenyl, cycloalkenyl, cycloalkadienyl, alkynyl, aralkyl, aralkenyl, or aralkynyl, and the like, including all substituted, unsubstituted, branched, linear, heteroatom substituted, and halogen substituted derivatives thereof, any one of which having from 1 to about 20 carbon atoms; halide; or hydrogen.

In one aspect, for example, the transition metal complex of this invention can comprise the terdentate pyridine diimine ligand 2,6-[(2,6-i-Pr₂C₆H₃)N═CMe]₂C₅H₃N, which has the structure shown as IIIa, and which is abbreviated herein as N³Py.

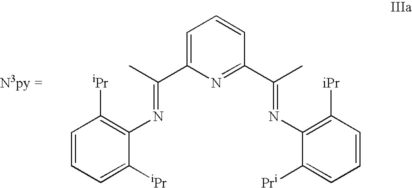

In another aspect of this invention, the transition metal complex can comprise various diimine type ligands, examples of which include, but are not limited to: [(2,6-i-Pr₂C₆H₃)N═CMe]₂, having the structure shown as IIIb; (C₉H₆N)-2-CH═N(2,6-i-Pr₂C₆H₃), having the structure shown as IIIc; [(2,6-i-Pr₂C₆H₃)N═CPh]₂ having the structure shown as IIId; and any combination thereof. 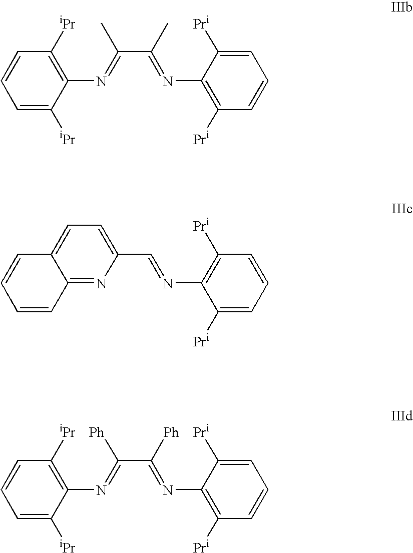
The quinoline-2-carboxaldimine compounds of the formula IIIc and the analogous pyridine-2-carboxaldimine compounds can be prepared as disclosed in U.S. Pat. Nos. 6,150,295 and 6,399,725, each of which is incorporated herein by reference in its entirety.

In yet another aspect of this invention, the transition metal compound of the catalyst composition comprises a Schiff base ligand, an example of which is shown as structure IV. In this structure, R and R′ are independently a hydrocarbyl group including, but not limited to, aryl, alkyl, cycloalkyl, alkenyl, cycloalkenyl, cycloalkadienyl, alkynyl, aralkyl, aralkenyl, or aralkynyl, and the like, including all substituted, unsubstituted, branched, linear, heteroatom substituted, and halogen substituted derivatives thereof, any one of which having from 1 to about 20 carbon atoms; halide; or hydrogen. Further, the two R groups can have either a cis- or trans-orientation relative to each other, that is, they can be situated on the same side (cis), or on opposite sides (trans) of the plane of the Schiff base ligand, as indicated by the wavy bond between the Schiff base core and one R group in the following structure. In addition, up to four R′ groups can be substituted on the aryl rings, indicated as R′ₙ, where R′ is independently as defined above.

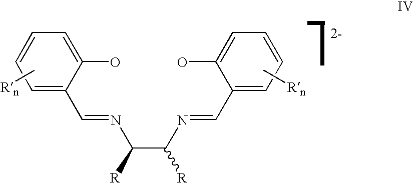

In still another aspect of this invention, the transition metal compound can comprise a potentially bidentate oxygen-donor ligand such as carboxylate, acetylacetonate, dialkylcarbamate, and the like, including substituted derivatives thereof. In another aspect, for example, the oxygen-donor ligands can be acetylacetonate [OCRCHCRO]⁻, carboxylate [O₂CR]⁻, or dialkylcarbamate [O₂CNR₂]⁻ ligands, wherein R is independently a hydrocarbyl group including, but not limited to, aryl, alkyl, cycloalkyl, alkenyl, cycloalkenyl, cycloalkadienyl, alkynyl, aralkyl, aralkenyl, or aralkynyl, and the like, including all substituted, unsubstituted, branched, linear, heteroatom substituted, and halogen substituted derivatives thereof, any one of which having from 1 to about 20 carbon atoms; halide; or hydrogen. In another aspect, for example, these ligands can be used with a first row transition metal. In another aspect, for example, the oxygen-donor ligand is hexafluoroacetylacetonate (hfacac), [OCCF₃CHCCF₃O]⁻ or trifluoroacetate (tfa), [O₂CCF₃]⁻, wherein the ligands can coordinate to the transitional metal in an η¹- or an η²-bonding mode. The structures of the hfacac and tfa ligands are shown in the structural formulas shown as Va and Vb respectively.

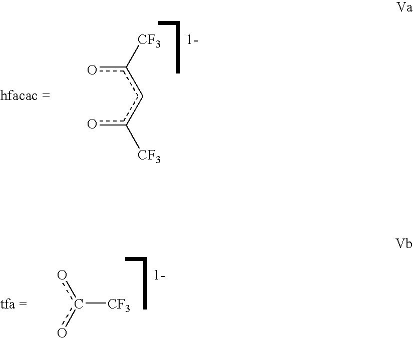

In yet another aspect of this invention, the catalyst composition comprises a transition metal compound of the formula [2,6-(RN═CR′)₂C₅H₃N]M(η²-OCRCHCRO)₂ (M═Ni or Fe), wherein R and R′ are independently a hydrocarbyl group including, but not limited to, aryl, alkyl, cycloalkyl, alkenyl, cycloalkenyl, cycloalkadienyl, alkynyl, aralkyl, aralkenyl, or aralkynyl, and the like, including all substituted, unsubstituted, branched, linear, heteroatom substituted, and halogen substituted derivatives thereof, any one of which having from 1 to about 20 carbon atoms; halide; or hydrogen. In another aspect, for example, the catalyst composition of this invention comprises compounds of the formula {2,6-[(2,6-i-Pr₂C₆H₃)N═CMe]₂C₅H₃N}M(η²-OCCF₃CHCCF₃O)₂, where M is Ni or Fe, with the structural formula shown in VI. 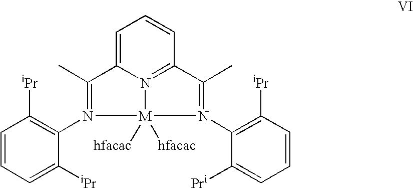
The abbreviation N₃py is used herein to refer to this particular neutral, terdentate ligand {2,6-[(2,6-i-Pr₂C₆H₃)N═CMe]₂C₅H₃N}, and the abbreviation hfacac is used herein to refer to the anionic hexafluoroacetylacetonate ligand. [OCCF₃CHCCF₃O]⁻, and thus these typical compounds are indicated as Ni(N₃py)(hfacac)₂ and Fe(N₃py)(hfacac)₂. These compounds are named [N,N′-(2,6-diisopropylphenyl)-2,6-pyridinacetyldiimine]iron(II)bis(1,1,1,5,5,5-hexafluoro-2,4-acetylacetonate) and [N,N′-(2,6-diisopropylphenyl)-2,6-pyridinacetyldiimine]nickel(II)bis(1,1,1,5,5,5-hexafluoro-2,4-acetylacetonate).

In the complexes M(N³Py)(hfacac)₂, where M is iron and nickel, both the N³Py and the hfacac ligands are capable of coordinating to the metal center in a multidentate fashion, namely tridentate-(η³)-N³Py and bidentate-(η²)-hfacac bonding modes are possible. The crystal structure of the iron chloride compound has been determined (Britovsek, G. J. P., Gibson, V. C., Kimberley, B. S., Maddox, P. J., McTavish, S. J., Solan, G. A., White, A. J. P., Williams, D. J., Chem. Commun. 1998, 849). However, for both ligands, it is possible to coordinate to a metal with less than all the donor ligands that are available. These ligands can be used in any number of transition metal coordination compounds to provide an active catalyst, regardless of whether the solid state or solution structure of these ligands in any particular complex is η^{1, 2, or 3}-N³Py or η^{1 or 2}-hfacac. Similarly, other multidentate ligands such as carboxylates, dithiocarbamates, diamines, triamines, bis(pyrazolyl)borates, tris(pyrazolyl)borates, and the like, can be useful as ligands in a transition metal compound that is used to prepare the catalyst composition of this invention, regardless of any particular bonding mode to the metal. Thus, in this aspect, for example, any potentially chelating ligand can be bonded to the transition metal with some or all of its donor atoms coordinated to the metal.

Similarly, this invention does not restrict the metal complex to a mononuclear species, that is, containing a single metal per molecule. Therefore, in another aspect, this invention comprises transition metal compounds comprising dinuclear, trinuclear, tetranuclear, and higher nuclearity clusters.

In one aspect, the amount of transition metal compound that is combined with the support can be from about 0.01 wt % to about 10 wt %, based on the combined weight of the transition metal compound and the support. This invention also performs well when this amount of transition metal compound is from about 0.1 wt % to about 3.0 wt %, or about 0.25 wt % to about 1.0 wt %, based on the combined weight of transition metal compound and the support.

In accordance with another aspect of this invention, the catalyst composition comprises a transition metal compound as described above and a clay support, combined with an aluminum alkyl and an olefin monomer, and is used for olefin polymerization, co-polymerization, or oligomerization. The transition metal compound can be combined with the clay support in any manner known in the art.

The Ion-Exchangable Support or “Activator-Support”

In one aspect of this invention, the activator-support used in preparing the catalyst compositions of this invention comprises an ion-exchangeable support, including but not limited to silicate and aluminosilicate compounds or minerals, either with layered or non-layered structures, and any combination thereof. In another aspect of this invention, ion-exchangeable, layered aluminosilicates such as pillared clays can be used as activator-supports.

In one aspect, the activator-support of this invention can comprise clay minerals having exchangeable cations and layers capable of expanding. The activator-support can also comprise clay minerals impregnated, ion-exchanged, or otherwise treated with metal oxides comprising Al, Ti, Cr, or any number of other metals, or any combination thereof, referred to as pillared clays. Although the term “support” is used, it is not meant to be construed as an inert component of the catalyst composition, but rather is to be considered an active part of the catalyst composition, because of its intimate association with the transition metal compound and cocatalyst components. While not intending to be bound by theory, it is believed that the ion exchangeable activator-support serves as an insoluble reactant that reacts with the transition metal compound and cocatalyst components to form a catalyst composition used to produce polymer.

In one aspect, the clay materials of this invention encompass materials either in their natural state or that have been treated with various ions by wetting, ion exchange, or pillaring. Typically, the clay material activator-support of this invention comprises clays that have been ion exchanged with large cations, including polynuclear, highly charged metal complex cations. However, the clay material activator-supports of this invention also encompass clays that have been ion exchanged with simple salts, including by not limited to, salts of Al(III), Fe(II), Fe(III), Zn(II), or any combination thereof. These salts can be compounds that comprise ligands such as halide, acetate, sulfate, nitrate, nitrite, or any combination thereof, or similar ligands.

In one aspect, the clay activator-support of this invention comprises pillared clays. The term pillared clays is used to refer to clay materials that have been ion exchanged with large, typically polynuclear, highly charged metal complex cations. Examples of such ions include, but are not limited to, Keggin ions which can have charges such as 7+, various polyoxometallates, and other large ions. Thus, the term pillaring refers to a simple exchange reaction in which the exchangeable cations of a clay material are replaced with large, highly charged ions, such as Keggin ions. These polymeric cations are then immobilized within the interlayers of the clay and when calcined are converted to metal oxide “pillars,” effectively supporting the clay layers as column-like structures. Thus, once the clay is dried and calcined to produce the supporting pillars between clay layers, the expanded lattice structure is maintained and the porosity is enhanced. The resulting pores can vary in shape and size as a function of the pillaring material and the parent clay material used. Examples of pillaring and pillared clays are found in: T. J. Pinnavaia, Science 220 (4595), 365-371 (1983); J. M. Thomas, Intercalation Chemistry, (S. Whittington and A. Jacobson, eds.) Ch. 3, pp. 55-99, Academic Press, Inc., (1972); U.S. Pat. No. 4,452,910; U.S. Pat. No. 5,376,611; and U.S. Pat. No. 4,060,480; each of which is incorporated herein in its entirety.

The pillaring process utilizes clay minerals having exchangeable cations and layers capable of expanding. Any pillared clay that can enhance the polymerization of olefins in the catalyst composition of the present invention can be used. Therefore, suitable clay minerals for pillaring include, but are not limited to: allophanes; smectites, both dioctahedral (Al) and tri-octahedral (Mg) and derivatives thereof such as montmorillonites (bentonites), nontronites, hectorites, or laponites; halloysites; vermiculites; micas; fluoromicas; chlorites; mixed-layer clays; the fiberous clays including but not limited to sepiolites, attapulgites, and palygorskites; a serpentine clay; illite; laponite; saponite; and any combination thereof. In one aspect, the pillared clay activator-support comprises bentonite or montmorillonite. The principal component of bentonite is montmorillonite.

The pillared clay can be pretreated in the present invention. For example, in one embodiment, a pillared bentonite was pretreated by drying at about 300° C. under an inert atmosphere, typically dry nitrogen, for about 3 hours, before being added to the polymerization reactor. This example of a pretreament is not limiting, because preheating steps such as this can be carried out at many other temperatures and times, including any combination of temperature and time steps, all of which are encompassed by this invention.

The ion-exchangeable activator-supports such as pillared clays used to prepare the catalyst compositions of this invention can be combined with other inorganic support materials, including, but are not limited to, zeolites, inorganic oxides, phosphated inorganic oxides, and the like. In one aspect, typical support materials that can be used in this regard include, but are not limited to, silica, silica-alumina, alumina, titania, zirconia, magnesia, boria, fluorided alumina, silated alumina, thoria, aluminophosphate, aluminum phosphate, phosphated silica, phosphated alumina, silica-titania, coprecipitated silica/titania, fluorided/silated alumina, and any combination or mixture thereof.

The amount of transition metal compound in relation to the ion-exchangeable activator-support used to prepare the catalyst composition of this invention is typically from about 0.1 wt % to about 15 wt % transition metal complex, based on the weight of the activator-support component (not based on the final transition metal compound-clay mixture). It was also found that from about 1 wt % to about 10 wt % transition metal compound works well to afford a catalyst that operates at desired activities.

The mixture of transition metal compound and clay can be contacted and mixed for any length of time to allow thorough contact between the transition metal compound and the activator-support. Sufficient deposition of the transition metal compound component on the clay can be achieved without heating a mixture of clay and transition metal complex. For example, the transition metal compound and the clay material are simply mixed from about room temperature to about 200° F. in order to achieve the deposition of the transition metal compound on the clay activator-support. In another aspect, the transition metal compound and the clay material are mixed from about 100° F. to about 180° F. in order to achieve the deposition of the ansa-metallocene on the clay activator-support. In this aspect, the time of contact is not critical, however the transition metal compound and clay can typically be contacted and mixed for any length of time, for example from about 0.1 minute to about 500 minutes, from about 0.5 minute to about 100 minutes, from about 1 minutes to about 60 minutes. Further in this aspect, the transition metal compound and the clay material can be heated together for about 1 to about 15 minutes before addition to the reactor.

A range of transition metal oxidation states are possible once the metal is deposited on the clay support and treated with a cocatalyst, through the complex chemical reaction manifolds that are occurring in this catalyst composition, including oxidations, reductions, and combinations thereof. In one aspect, the cocatalyst comprises an organoaluminum compound. While not intending to be bound by theory, in the case of lower oxidation state transition metal compounds, it is possible that the organoaluminum compound functions primarily as an alkylating agent, with the reducing function being less important. Further, it is quite possible that there is not a single oxidation state of the active catalyst, as there are likely other transition metal oxidation states that are present and function as active sites in the catalyst produced as disclosed herein.

The Organometal Cocatalyst

In one aspect, the catalyst composition of this invention comprises at least one transition metal compound in which the metal has a d^{4≦n≦8} electron configuration, at least one pillared clay, and at least one organometal cocatalyst.

In one aspect, for example, the organometal cocatalyst of this invention includes, but is not limited to, an organoaluminum compound, an aluminoxane, an organoboron compound, an organozinc compound, or any combinations thereof.

Organoaluminum Cocatalysts

In one aspect, the present invention provides a catalyst composition comprising an organometal cocatalyst; which can comprise at least one organoaluminum compound. Thus, an organoaluminum compound alone can be used as the organometal cocatalyst of the catalyst composition of this invention, or an organoaluminum compound can be used in combination with other cocatalysts, including, but not limited to, another organoaluminum compound, an aluminoxane, an organoboron compound, an organozinc compound, or any combination thereof.

In one aspect, suitable organoaluminum compounds that can be used in this invention include, but are not limited to, compounds with the formula:
Al(X⁵)ₙ(X⁶)₃₋ₙ,
wherein (X⁵) is a hydrocarbyl having from 1 to about 20 carbon atoms; (X⁶) is alkoxide or aryloxide, any one of which having from 1 to about 20 carbon atoms, halide, or hydride; and n is a number from 1 to 3, inclusive. In one aspect, for example, (X⁵) can be independently an alkyl, aryl, alkenyl, alkaryl, or aralkyl, any one of which having from 1 to about 20 carbon atoms; halide; or hydride. In yet another aspect, (X⁵) can be an alkyl having from 1 to about 20 carbon atoms. Examples of (X⁵) moieties include, but are not limited to, methyl, ethyl, propyl, n-butyl, sec-butyl, isobutyl, pentyl, hexyl, and the like. In another aspect, (X⁶) can be independently fluoro or chloro. In yet another aspect, (X⁶) can be chloro.

In one aspect of this invention, the utility of an organoaluminum compound is not restricted to any particular structural motif, nor to the presence of a monomeric compound of the formula Al(X⁵)ₙ(X⁶)₃₋ₙ. Thus, in one aspect, monomeric and cluster organoaluminum compounds are encompassed by the present invention. In one aspect, in the formula Al(X⁵)ₙ(X⁶)₃₋ₙ, n is a number from 1 to 3 inclusive, and typically, n is 3. However, the value of n is not restricted to be an integer, therefore this formula includes sesquihalide compounds of the formula Al₂(X⁵)₃(X⁶)₃, that are typically in equilibrium with their disproportionation products, Al₂(X⁵)₄(X⁶)₂ and Al₂(X⁵)₂(X⁶)₄, examples of which include, but are not limited to, dialkyl aluminum halide and alkyl aluminum dihalide compounds, respectively.

In still another aspect of this invention, the organoaluminum cocatalyst of this invention includes cocatalysts that comprise base adducts of Al(X⁵)ₙ(X⁶)₃₋ₙ of the formula Al(X⁵)ₙ(X⁶)₃₋ₙLₘ, wherein L is a Lewis base, and n is a number from 1 to about 3, inclusive, and m is a number from 0 to about 4.

Examples of organoaluminum compounds that can be used as organometal cocatalysts include, but are not limited to, trialkylaluminum compounds, dialkylaluminum halide compounds, dialkylaluminum alkoxide compounds, dialkylaluminum hydride compounds, alkylaluminum sesquihalide compounds, and the like, including any combination thereof. Examples of organoaluminum compounds that are useful in this invention include, but are not limited to: trimethylaluminum (TMA); triethylaluminum (TEA); tripropylaluminum; diethylaluminum ethoxide; tributylaluminum; disobutylaluminum hydride; triisobutylaluminum (TIBAL); and diethylaluminum chloride.

Further, more than one organoaluminum compound can be used in the present invention. In one aspect, the order of addition of catalyst components is not critical to this invention, and it is also not necessary that all the organoaluminum compounds be added in a single step. In another aspect, when an organoaluminum compound is added in multiple steps, the amounts of organoaluminum compound disclosed herein include the total amount of organoaluminum compound used in the catalyst composition. Therefore, total amounts of organoaluminum compounds are disclosed, regardless of whether a single organoaluminum compound is used, or more than one organoaluminum compound.

In one aspect, examples of organoaluminum cocatalysts include, but are not limited to, trimethylaluminum (TMA), triethylaluminum (TEA), triisobutylaluminum (TIBAL), ethylaluminum sesquichloride, ethylaluminum dichloride, diethylaluminum chloride, methylaluminum dibromide, ethylaluminum diiodide, isobutylaluminum dichloride, dodecylaluminum dibromide, dimethylaluminum bromide, diisopropylaluminum chloride, methyl-n-propylaluminum bromide, di-n-octylaluminum bromide, diphenylaluminum chloride, dicyclohexylaluminum bromide, dieicosylaluminum chloride, methylaluminum sesquibromide, ethylaluminum sesquiiodide, and related compounds, and any combination thereof. In another aspect, the organometal cocatalyst of this invention comprises trialkylaluminum, dialkylaluminumhalide, alkylaluminumdihalide compounds, alkylaluminum sesquihalide compounds, and combinations thereof. In a further aspect, for example, the organometal cocatalyst comprises trimethylaluminum.

Any amount of activating organometal cocatalyst that is sufficient to activate or react with the transition metal compound and the support component to impart some polymerization activity, can be used in this invention. In one aspect, desirable polymerization activity is achieved when the amount of aluminum alkyl compound used provides an aluminum/transition metal molar ratio of between about 0.1:1 to about 10,000:1. Typically, an amount of aluminum alkyl compound is used such that the aluminum/transition metal molar ratio is between about 1:1 to about 1,000:1, to provide suitable catalytic activity. More typically, the aluminum/transition metal molar ratio is between about 10:1 to about 1,000:1, to provide suitable catalytic activity.

In one embodiment, Fe(N³Py)(hfacac)₂ is impregnated onto a bentonite support, and trimethylaluminum (TMA) is used as the cocatalyst. All components of the catalyst composition were added directly to the reactor to provide an aluminum/transition metal molar ratio of between about 1:1 to about 1,000:1. However, the amount of cocatalyst employed can vary with the catalyst support used.

Aluminoxane Cocatalyts

In one aspect, the present invention provides a catalyst composition comprising at least one organometal cocatalyst, which can comprise at least one aluminoxane. Thus, an aluminoxane alone can be used as the organometal cocatalyst of the catalyst composition of this invention, or an aluminoxane can be used in combination with other cocatalysts, including, but not limited to, an organoaluminum compound, another aluminoxane, an organoboron compound, an organozinc compound, or any combination thereof.

Aluminoxanes are also referred to as poly(hydrocarbyl aluminum oxides) or organoaluminoxanes. The other catalyst components are typically contacted with the aluminoxane in a saturated hydrocarbon compound solvent, though any solvent which is substantially inert to the reactants, intermediates, and products of the activation step can be used. The catalyst composition formed in this manner can be collected by methods known to those of skill in the art, including but not limited to filtration, or the catalyst composition can be introduced into the polymerization reactor without being isolated. In another aspect, the individual catalyst components can be introduced directly into the polymerization reactor where their initial contact occurs, in order to form the catalyst composition.

The aluminoxane compound of this invention is an oligomeric aluminum compound, wherein the aluminoxane compound can comprise linear structures, cyclic, or cage structures, or typically mixtures of all three. Cyclic aluminoxane compounds having the formula: 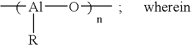
R is a linear or branched alkyl having from 1 to 10 carbon atoms, and n is an integer from 3 to about 10 are encompassed by this invention. The (AlRO)ₙ moiety shown here also constitutes the repeating unit in a linear aluminoxane. Thus, linear aluminoxanes having the formula: 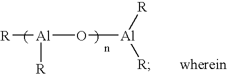
R is a linear or branched alkyl having from 1 to 10 carbon atoms, and n is an integer from 1 to about 50, are also encompassed by this invention.

Further, aluminoxanes can also have cage structures of the formula R^{t}₅ₘ₊ₐR^{b}ₘ₋ₐAl₄ₘO₃ₘ, wherein m is 3 or 4 and a is =n_{Al(3)}−n_{O(2)}+n_{O(4)}; wherein n_{Al(3)} is the number of three coordinate aluminum atoms, n_{O(2)} is the number of two coordinate oxygen atoms, n_{O(4)} is the number of 4 coordinate oxygen atoms, R^{t} represents a terminal alkyl group, and R^{b} represents a bridging alkyl group; wherein R is a linear or branched alkyl having from 1 to 10 carbon atoms.

Thus, aluminoxanes that can serve as cocatalysts in this invention are generally represented by formulas such as (R—Al—O)ₙ, R(R—Al—O)ₙAlR₂, and the like, wherein the R group is typically a linear or branched C₁-C₆ alkyl such as methyl, ethyl, propyl, butyl, pentyl, or hexyl wherein n typically represents an integer from 1 to about 50. In one embodiment, the aluminoxane compounds of this invention include, but are not limited to, methylaluminoxane, ethylaluminoxane, n-propylaluminoxane, iso-propylaluminoxane, n-butylaluminoxane, t-butylaluminoxane, sec-butylaluminoxane, iso-butylaluminoxane, 1-pentylaluminoxane, 2-pentylaluminoxane, 3-pentylaluminoxane, iso-pentylaluminoxane, neopentylaluminoxane, or any combination thereof.

While organoaluminoxanes with different types of R groups are encompassed by the present invention, in one aspect, methyl aluminoxane (MAO), ethyl aluminoxane, or isobutyl aluminoxane can be typical cocatalysts used in the catalyst composition of this invention. These aluminoxanes are prepared from trimethylaluminum, triethylaluminum, or triisobutylaluminum, respectively, and are sometimes referred to as poly(methyl aluminum oxide), poly(ethyl aluminum oxide), and poly(isobutyl aluminum oxide), respectively. In another aspect of this invention, an aluminoxane is used in combination with a trialkylaluminum, such as disclosed in U.S. Pat. No. 4,794,096, which is herein incorporated by reference in its entirety.

The present invention contemplates many values of n in the aluminoxane formulas (R—Al—O)ₙ and R(R—Al—O)ₙAlR₂. In one aspect, for example, n can be at least about 3. However, depending upon how the organoaluminoxane is prepared, stored, and used, the value of n can be variable within a single sample of aluminoxane, and such a combination of organoaluminoxanes are comprised in the methods and compositions of the present invention.

In preparing the catalyst composition of this invention comprising an aluminoxane, the molar ratio of the aluminum in the aluminoxane to the transition metal compound in the composition is usually from about 1:10 to about 100,000:1. In another aspect, the molar ratio of the aluminum in the aluminoxane to the transition metal compound in the composition is usually from about 5:1 to about 15,000:1. The amount of aluminoxane added to a polymerization zone is an amount within a range of about 0.01 mg/L to about 1000 mg/L, from about 0.1 mg/L to about 100 mg/L, or from about 1 mg/L to about 50 mg/L.

Organoaluminoxanes can be prepared by various procedures which are well known in the art. Examples of organoaluminoxane preparations are disclosed in U.S. Pat. Nos. 3,242,099 and 4,808,561, each of which is incorporated by reference herein, in its entirety. One example of how an aluminoxane can be prepared is as follows. Water which is dissolved in an inert organic solvent can be reacted with an aluminum alkyl compound such as AlR₃ to form the desired organoaluminoxane compound. While not intending to be bound by this statement, it is believed that this synthetic method can afford a mixture of both linear and cyclic (R—Al—O)ₙ aluminoxane species, both of which are encompassed by this invention. Alternatively, organoaluminoxanes can be prepared by reacting an aluminum alkyl compound such as AlR₃ with a hydrated salt, such as hydrated copper sulfate, in an inert organic solvent.

Organoboron Cocatalysts

In one aspect, the present invention provides a catalyst composition comprising an organometal cocatalyst, which can comprise at least one organoboron compound. Thus, an organoboron compound alone can be used as the organometal cocatalyst of the catalyst composition of this invention, or an organoboron compound can be used in combination with other cocatalysts, including, but not limited to, an organoaluminum compound, an aluminoxane, another organoboron compound, an organozinc compound, or any combination thereof.

In one aspect, the organoboron compound cocatalyst comprises neutral boron compounds, borate salts, or combinations thereof. In another aspect, for example, the organoboron compounds of this invention can comprise a fluoroorgano boron compound, a fluoroorgano borate compound, or a combination thereof. Any fluoroorgano boron or fluoroorgano borate compound known in the art can be utilized. The term fluoroorgano boron compounds has its usual meaning to refer to neutral compounds of the form BY₃. The term fluoroorgano borate compound also has its usual meaning to refer to the monoanionic salts of a fluoroorgano boron compound of the form [cation]⁺[BY₄]⁻, where Y represents a fluorinated organic group. For convenience, fluoroorgano boron and fluoroorgano borate compounds are typically referred to collectively by organoboron compounds, or by either name as the context requires.

In another aspect, examples of fluoroorgano borate compounds that can be used as cocatalysts in the present invention include, but are not limited to, fluorinated aryl borates such as, N,N-dimethylanilinium tetrakis-(pentafluorophenyl)borate, triphenylcarbenium tetrakis(pentafluorophenyl)borate, lithium tetrakis(pentafluorophenyl)borate, N,N-dimethylanilinium tetrakis[3,5-bis(trifluoromethyl)phenyl]borate, triphenylcarbenium tetrakis[3,5-bis(trifluoromethyl)phenyl]borate, and the like, including mixtures thereof. Examples of fluoroorgano boron compounds that can be used as cocatalysts in the present invention include, but are not limited to, tris(pentafluorophenyl)boron, tris[3,5-bis(trifluoromethyl)phenyl]boron, and the like, including mixtures thereof.

While not intending to be bound by the following theory, these examples of fluoroorgano borate and fluoroorgano boron compounds, and related compounds, are thought to form “weakly-coordinating” anions when combined with organometal compounds, as disclosed in U.S. Pat. No. 5,919,983, which is incorporated herein by reference in its entirety.

Generally, any amount of organoboron compound can be utilized in this invention. In one aspect, the molar ratio of the organoboron compound to the transition metal compound in the composition is from about 0.1:1 to about 10:1. Typically, the amount of the fluoroorgano boron or fluoroorgano borate compound used as a cocatalyst for the transition metal compound is in a range of from about 0.5 mole to about 10 moles of boron compound per mole of transition metal compound. In one aspect, the amount of fluoroorgano boron or fluoroorgano borate compound used as a cocatalyst for the transition metal compound is in a range of from about 0.8 mole to about 5 moles of boron compound per mole of transition metal compound.

Organozinc Cocatalysts

In one aspect, the present invention provides a catalyst composition comprising an organometal cocatalyst, which can comprise at least one organozinc compound. Thus, an organozinc compound alone can be used as the organometal cocatalyst of the catalyst composition of this invention, or an organozinc compound can be used in combination with other cocatalysts, including, but not limited to, an organoaluminum compound, an aluminoxane, an organoboron compound, another organozinc compound, or any combination thereof.

In one aspect, the catalyst composition of the present invention comprises an organozinc cocatalyst, with the following formula:
Zn(X⁵)(X⁶);
wherein (X⁵) is a hydrocarbyl having from 1 to about 20 carbon atoms; (X⁶) is a hydrocarbyl, an alkoxide or an aryloxide having from 1 to about 20 carbon atoms, halide, or hydride.

In another aspect, examples of organozinc cocatalyst that can be used in the present invention include, but are not limited to, dimethylzinc, diethylzinc, di-n-propylzinc, di-i-propylzinc, di-n-butylzinc, di-s-butylzinc, di-t-butylzinc, dineopentylzinc, di(trimethylsilylmethyl)zinc, and the like, including any combinations thereof.

The Optional Ionizing Ionic Compound

The present invention provides new catalyst compositions comprising at least one transition metal compound catalyst, at least one cocatalyst, and at least one support. In one aspect, the cocatalyst comprises an organoaluminum compound, an aluminoxane, an organoboron compound, an organozinc compound, or any combination thereof. In another aspect, hydrogen is an optional component of the catalyst composition. In yet another aspect, at least one ionizing ionic compound is an optional component of the catalyst composition.

An ionizing ionic compound is an ionic compound which can function to enhance activity of the catalyst composition. While not bound by theory, it is believed that the ionizing ionic compound can be capable of reacting with the transition metal compound and converting it into a cationic transition metal compound. Again, while not intending to be bound by theory, it is believed that the ionizing ionic compound can function as an ionizing compound by completely or partially extracting an anionic ligand from the transition metal compound. However, the ionizing ionic compound can be an activator regardless of whether it ionizes the transition metal compound, abstracts a ligand in a fashion as to form an ion pair, weakens a metal-ligand bond in the transition metal compound, simply coordinates to a ligand, or any other mechanisms or combination thereof by which activation can occur. Further, it is not necessary that the ionizing ionic compound activate the transition metal compound only. The activation function of the ionizing ionic compound can be evident in the enhanced activity of catalyst composition as a whole, as compared to a catalyst composition containing catalyst composition that does not comprise any ionizing ionic compound.

In one aspect, examples of ionizing ionic compounds include, but are not limited to, the following compounds: tri(n-butyl)ammonium tetrakis(p-tolyl)borate, tri(n-butyl)ammonium tetrakis(m-tolyl)borate, tri(n-butyl)ammonium tetrakis(2,4-dimethyl)borate, tri(n-butyl)ammonium tetrakis(3,5-dimethylphenyl)borate, tri(n-butyl)ammonium tetrakis[3,5-bis(trifluoromethyl)phenyl]borate, tri(n-butyl)ammonium tetrakis(pentafluorophenyl)borate, N,N-dimethylanilinium tetrakis(p-tolyl)borate, N,N-dimethylanilinium tetrakis(m-tolyl)borate, N,N-dimethylanilinium tetrakis(2,4-dimethylphenyl)borate, N,N-dimethylanilinium tetrakis(3,5-dimethylphenyl)borate, N,N-dimethylanilinium tetrakis[3,5-bis(trifluoro-methyl)phenyl]borate, N,N-dimethylanilinium tetrakis(pentafluorophenyl)borate, triphenylcarbenium tetrakis(p-tolyl)borate, triphenylcarbenium tetrakis(m-tolyl)borate, triphenylcarbenium tetrakis(2,4-dimethylphenyl)borate, triphenylcarbenium tetrakis(3,5-dimethylphenyl)borate, triphenylcarbenium tetrakis[3,5-bis(trifluoromethyl)phenyl]borate, triphenylcarbenium tetrakis(pentafluorophenyl)borate, tropylium tetrakis(p-tolyl)borate, tropylium tetrakis(m-tolyl)borate, tropylium tetrakis(2,4-dimethylphenyl)borate, tropylium tetrakis(3,5-dimethylphenyl)borate, tropylium tetrakis[3,5-bis(trifluoro-methyl)phenyl]borate, tropylium tetrakis(pentafluorophenyl)borate, lithium tetrakis(pentafluorophenyl)borate, lithium tetrakis(phenyl)borate, lithium tetrakis(p-tolyl)borate, lithium tetrakis(m-tolyl)borate, lithium tetrakis(2,4-dimethylphenyl)borate, lithium tetrakis(3,5-dimethylphenyl)borate, lithium tetrafluoroborate, sodium tetrakis(pentafluorophenyl)borate, sodium tetrakis(phenyl) borate, sodium tetrakis(p-tolyl)borate, sodium tetrakis(m-tolyl)borate, sodium tetrakis(2,4-dimethylphenyl)borate, sodium tetrakis(3,5-dimethylphenyl)borate, sodium tetrafluoroborate, potassium tetrakis-(pentafluorophenyl)borate, potassium tetrakis(phenyl)borate, potassium tetrakis(p-tolyl)borate, potassium tetrakis(m-tolyl)borate, potassium tetrakis(2,4-dimethylphenyl)borate, potassium tetrakis(3,5-dimethylphenyl)borate, potassium tetrafluoroborate, tri(n-butyl)ammonium tetrakis(p-tolyl)aluminate, tri(n-butyl)ammonium tetrakis(m-tolyl)aluminate, tri(n-butyl)ammonium tetrakis(2,4-dimethyl)aluminate, tri(n-butyl)ammonium tetrakis(3,5-dimethylphenyl)aluminate, tri(n-butyl)ammonium tetrakis(pentafluorophenyl)aluminate, N,N-dimethylanilinium tetrakis(p-tolyl)-aluminate, N,N-dimethylanilinium tetrakis(m-tolyl)aluminate, N,N-dimethylanilinium tetrakis(2,4-dimethylphenyl)aluminate, N,N-dimethylanilinium tetrakis(3,5-dimethylphenyl)aluminate, N,N-dimethylanilinium tetrakis (pentafluorophenyl)aluminate, triphenylcarbenium tetrakis(p-tolyl)aluminate, triphenylcarbenium tetrakis(m-tolyl)aluminate, triphenylcarbenium tetrakis(2,4-dimethylphenyl)aluminate, triphenylcarbenium tetrakis(3,5-dimethylphenyl)aluminate, triphenylcarbenium tetrakis-(pentafluorophenyl)aluminate, tropylium tetrakis(p-tolyl)aluminate, tropylium tetrakis(m-tolyl)aluminate, tropylium tetrakis(2,4-dimethylphenyl)aluminate, tropylium tetrakis(3,5-dimethylphenyl)aluminate, tropylium tetrakis(pentafluoro-phenyl)aluminate, lithium tetrakis(pentafluorophenyl)aluminate, lithium tetrakis-(phenyl)aluminate, lithium tetrakis(p-tolyl)aluminate, lithium tetrakis(m-tolyl)aluminate, lithium tetrakis(2,4-dimethylphenyl)aluminate, lithium tetrakis(3,5-dimethylphenyl)aluminate, lithium tetrafluoroaluminate, sodium tetrakis(pentafluorophenyl)aluminate, sodium tetrakis(phenyl)aluminate, sodium tetrakis(p-tolyl)aluminate, sodium tetrakis(m-tolyl)aluminate, sodium tetrakis(2,4-dimethylphenyl)aluminate, sodium tetrakis(3,5-dimethylphenyl)aluminate, sodium tetrafluoroaluminate, potassium tetrakis(pentafluorophenyl)aluminate, potassium tetrakis(phenyl)aluminate, potassium tetrakis(p-tolyl)aluminate, potassium tetrakis(m-tolyl)aluminate, potassium tetrakis(2,4-dimethylphenyl)aluminate, potassium tetrakis (3,5-dimethylphenyl)aluminate, potassium tetrafluoroaluminate, or any combination thereof. However, the ionizing ionic compound is not limited thereto in the present invention.

Olefin Co-monomers

Unsaturated reactants that are useful in the polymerization processes with catalyst compositions and processes of this invention include olefin compounds having from about 2 to about 30 carbon atoms per molecule and having at least one olefinic double bond. This invention encompasses homopolymerization processes using a single olefin such as ethylene or propylene, as well as copolymerization reactions with at least one different olefinic compound. Typically, copolymers of ethylene comprise a major amount of ethylene (>50 mole percent) and a minor amount of comonomer (<50 mole percent), though this is not a requirement. The comonomers that can be copolymerized with ethylene should have from three to about 20 carbon atoms in their molecular chain.

When a copolymer is desired, the monomer ethylene is typically copolymerized with a comonomer typically, but not necessarily, comprising 1-butene, 1-pentene, 1-hexene, 1-octene, 1-decene or styrene. The amount of comonomer introduced into a reactor zone to produce the copolymer is generally from about 0.01 to about 10 weight percent comonomer based on the total weight of the monomer and comonomer. More typically, the amount of comonomer introduced into a reactor zone is from about 0.01 to about 5 weight percent comonomer, and most typically from about 0.1 to about 4 weight percent comonomer based on the total weight of the monomer and comonomer. Alternatively, an amount sufficient to give the above described concentrations by weight, in the copolymer produced can be used.

Acyclic, cyclic, polycyclic, terminal (α), internal, linear, branched, substituted, unsubstituted, functionalized, and non-functionalized olefins can be employed in this invention. For example, typical unsaturated compounds that can be polymerized with the catalysts of this invention include, but are not limited to, propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-hexene, 3-ethyl-1-hexene, 1-heptene, 2-heptene, 3-heptene, the four normal octenes, the four normal nonenes, the five normal decenes, and mixtures of any two or more thereof. Cyclic and bicyclic olefins, including but not limited to, cyclopentene, cyclohexene, norbornylene, norbornadiene, and the like, can also be polymerized as described above.

While not intending to be bound by this theory, in the event that branched, substituted, or functionalized olefins are used as reactants, it is believed that steric hindrance can impede and/or slow the polymerization process. Thus, branched and/or cyclic portion(s) of the olefin removed somewhat from the carbon-carbon double bond would not be expected to hinder the reaction in the way that the same olefin substituents situated more proximate to the carbon-carbon double bond might. Typically, at least one reactant for the catalyst compositions of this invention is ethylene, so the polymerizations are either homopolymerizations or copolymerizations with a different acyclic, cyclic, terminal, internal, linear, branched, substituted, or unsubstituted olefin. In addition, the catalyst compositions of this invention can be used in polymerization of diolefin compounds, including but are not limited to, 1,3-butadiene, isoprene, 1,4-pentadiene, and 1,5-hexadiene.

Utility of the Catalyst Composition in Polymerization Processes

Polymerizations using the catalysts of this invention can be carried out in any manner known in the art. Such processes that can polymerize monomers into polymers include, but are not limited to slurry polymerizations, gas phase polymerizations, solution polymerizations, and multi-reactor combinations thereof. Thus, any polymerization zone known in the art to produce olefin-containing polymers can be utilized. For example, a stirred reactor can be utilized for a batch process, or the reaction can be carried out continuously in a loop reactor or in a continuous stirred reactor. Typically, the polymerizations disclosed herein are carried out using a slurry polymerization process in a loop reaction zone. Suitable diluents used in slurry polymerization are well known in the art and include hydrocarbons which are liquid under reaction conditions. The term “diluent” as used in this disclosure does not necessarily mean an inert material, as this term is meant to include compounds and compositions that can contribute to polymerization process. Examples of hydrocarbons that can be used as diluents include, but are not limited to, cyclohexane, isobutane, n-butane, propane, n-pentane, isopentane, neopentane, and n-hexane. Typically, isobutane is used as the diluent in a slurry polymerization. Examples of this technology are found in U.S. Pat. Nos. 4,424,341; 4,501,885; 4,613,484; 4,737,280; and 5,597,892; each of which is incorporated by reference herein, in its entirety. Polymerization reactors suitable for the present invention can comprise at least one raw material feed system, at least one feed system for catalyst or catalyst components, at least one reactor system, at least one polymer recovery system or any suitable combination thereof. Suitable reactors for the present invention can further comprise any one, or combination of, a catalyst storage system, an extrusion system, a cooling system, a diluent recycling system, or a control system. Such reactors can comprise continuous take-off and direct recycling of catalyst, diluent, and polymer. Generally, continuous processes can comprise the continuous introduction of a monomer, a catalyst, and a diluent into a polymerization reactor and the continuous removal from this reactor of a suspension comprising polymer particles and the diluent.

Polymerization reactor systems of the present invention can comprise one type of reactor per system or multiple reactor systems comprising two or more types of reactors operated in parallel or in series. Multiple reactor systems can comprise reactors connected together to perform polymerization, or reactors that are not connected. The polymer can be polymerized in one reactor under one set of conditions, and then the polymer can be transferred to a second reactor for polymerization under a different set of conditions.

In one aspect of the invention, the polymerization reactor system can comprise at least one loop slurry reactor. Such reactors are known in the art and can comprise vertical or horizontal loops. Such loops can comprise a single loop or a series of loops. Multiple loop reactors can comprise both vertical and horizontal loops. The slurry polymerization can be performed in an organic solvent that can disperse the catalyst and polymer. Examples of suitable solvents include butane, hexane, cyclohexane, octane, and isobutane. Monomer, solvent, catalyst and any comonomer are continuously fed to a loop reactor where polymerization occurs. Polymerization can occur at low temperatures and pressures. Reactor effluent can be flashed to remove the solid resin.

In yet another aspect of this invention, the polymerization reactor can comprise at least one gas phase reactor. Such systems can employ a continuous recycle stream containing one or more monomers continuously cycled through the fluidized bed in the presence of the catalyst under polymerization conditions. The recycle stream can be withdrawn from the fluidized bed and recycled back into the reactor. Simultaneously, polymer product can be withdrawn from the reactor and new or fresh monomer can be added to replace the polymerized monomer. Such gas phase reactors can comprise a process for multi-step gas-phase polymerization of olefins, in which olefins are polymerized in the gaseous phase in at least two independent gas-phase polymerization zones while feeding a catalyst-containing polymer formed in a first polymerization zone to a second polymerization zone.

In still another aspect of the invention, the polymerization reactor can comprise a tubular reactor. Tubular reactors can make polymers by free radical initiation, or by employing the catalysts typically used for coordination polymerization. Tubular reactors can have several zones where fresh monomer, initiators, or catalysts are added. Monomer can be entrained in an inert gaseous stream and introduced at one zone of the reactor. Initiators, catalysts, and/or catalyst components can be entrained in a gaseous stream and introduced at another zone of the reactor. The gas streams are intermixed for polymerization. Heat and pressure can be employed appropriately to obtain optimal polymerization reaction conditions.

In another aspect of the invention, the polymerization reactor can comprise a solution polymerization reactor. During solution polymerization, the monomer is contacted with the catalyst composition by suitable stirring or other means. A carrier comprising an inert organic diluent or excess monomer can be employed. If desired, the monomer can be brought in the vapor phase into contact with the catalytic reaction product, in the presence or absence of liquid material. The polymerization zone is maintained at temperatures and pressures that will result in the formation of a solution of the polymer in a reaction medium. Agitation can be employed during polymerization to obtain better temperature control and to maintain uniform polymerization mixtures throughout the polymerization zone. Adequate means are utilized for dissipating the exothermic heat of polymerization. The polymerization can be effected in a batch manner, or in a continuous manner. The reactor can comprise a series of at least one separator that employs high pressure and low pressure to separate the desired polymer.

In a further aspect of the invention, the polymerization reactor system can comprise the combination of two or more reactors. Production of polymers in multiple reactors can include several stages in at least two separate polymerization reactors interconnected by a transfer device making it possible to transfer the polymers resulting from the first polymerization reactor into the second reactor. The desired polymerization conditions in one of the reactors can be different from the operating conditions of the other reactors. Alternatively, polymerization in multiple reactors can include the manual transfer of polymer from one reactor to subsequent reactors for continued polymerization. Such reactors can include any combination including, but not limited to, multiple loop reactors, multiple gas reactors, a combination of loop and gas reactors, a combination of autoclave reactors or solution reactors with gas or loop reactors, multiple solution reactors, or multiple autoclave reactors.

Polymerization temperature for this invention typically ranges from about 60° C. to about 280° C., with a polymerization reaction temperature more typically operating between about 70° C. to about 110° C.

The polymerization reaction typically occurs in an inert atmosphere, that is, in atmosphere substantially free of oxygen and under substantially anhydrous conditions, thus, in the absence of water as the reaction begins. Therefore a dry, inert atmosphere, for example, dry nitrogen or dry argon, can be employed in the polymerization reactor.

The polymerization reaction pressure can be any pressure that does not adversely affect the polymerization reaction, and it can be at a pressure higher than the pretreatment pressures. Generally, polymerization pressures are from about atmospheric pressure to about 1000 psig, more typically from about 50 psig to about 800 psig. Further, hydrogen can be used in the polymerization process of this invention to control polymer molecular weight.

After the polymers are produced, they can be formed into various articles, including but not limited to, household containers, utensils, film products, drums, fuel tanks, pipes, geomembranes, and liners. Various processes can form these articles. Usually, additives and modifiers are added to the polymer in order to provide desired effects. By using the invention described herein, articles can likely be produced at a lower cost, while maintaining most or all of the unique properties of polymers produced with metallocene catalysts.

Unless defined otherwise, all technical and scientific terms used herein have the same meaning as commonly understood to one of ordinary skill in the art to which this invention belongs. Although any methods, devices, and materials similar or equivalent to those described herein can be used in the practice or testing of the invention, the preferred methods, devices and materials are herein described.

All publications and patents mentioned herein are incorporated herein by reference for the purpose of describing and disclosing, for example, the constructs and methodologies that are described in the publications, which might be used in connection with the presently described invention. The publications. discussed above and throughout the text are provided solely for their disclosure prior to the filing date of the present application. Nothing herein is to be construed as an admission that the inventors are not entitled to antedate such disclosure by virtue of prior invention. Further, to the extent that any definition or usage provided by any document incorporated herein by reference conflicts with the definition or usage provided herein, the definition or usage provided herein controls.

For any particular compound disclosed herein, any general structure presented also encompasses all conformational isomers, regioisomers, and stereoisomers that can arise from a particular set of substituents. The general structure also encompasses all enantiomers, diastereomers, and other optical isomers whether in enantiomeric or racemic forms, as well as mixtures of stereoisomers, as the context requires.

The present invention is further illustrated by the following examples, which are not to be construed in any way as imposing limitations upon the scope thereof. On the contrary, it is to be clearly understood that resort can be had to various other embodiments, modifications, and equivalents thereof which, after reading the description herein, can suggest themselves to one of ordinary skill in the art without departing from the spirit of the present invention or the scope of the appended claims.

### EXAMPLE 1

General Details

In the following examples, unless otherwise specified, the syntheses and preparations described therein were carried out under an inert atmosphere such as nitrogen and/or argon. Solvents were purchased from commercial sources and were typically dried over activated alumina prior to use. Trimethylaluminum (TMA) was purchased from commercial sources, typically as a 2.0 Molar solution in hexanes. The Bentonite used for all experiments was purchased from American Colloid Company under its trade name Volclay™ and used without further purification. The clay that was used was pillared using conventional techniques described in: T. J. Pinnavaia, Science 220 (4595), 365-371 (1983); J. M. Thomas, Intercalation Chemistry, (S. Whittington and A. Jacobson, eds.) Ch. 3, pp. 55-99, Academic Press, Inc., (1972); U.S. Pat. No. 4,452,910; U.S. Pat. No. 5,376,611; and U.S. Pat. No. 4,060,480; each of which is incorporated herein by reference in its entirety.

The polymerization reaction was typically carried out in the substantial absence of oxygen, which can deactivate the catalyst, and under substantially anhydrous conditions, that is, in the initial absence of water. The polymerization reaction pressure was any pressure which does not adversely affect the reaction. Generally, pressures within the range from atmospheric to just under the bubble point of ethylene in isobutane over a temperature range from 25° to 110° C. were employed.

Catalysts of the present invention were tested by polymerizing ethylene, and comparing the results obtained with those from other olefin polymerization catalysts. The results of these experiments are presented in Table 1 for the iron/clay/TMA catalyst system, and Table 2 for the nickel/clay/TMA catalyst system (TMA=trimethylaluminum).

Melt index (MI, g/10 min) was determined in accordance with ASTM D1238 condition F at 190° C. with a 2,160 gram weight.

High load melt index (HLMI, g/10 min) was determined in accordance with ASTM D1238 condition E at 190° C. with a 21,600 gram weight.

Polymer density was determined in grams per cubic centimeter (g/cc) on a compression molded sample, cooled at about 15° C. per hour, and conditioned for about 40 hours at room temperature in accordance with ASTM D1505 and ASTM D1928, procedure C.

### EXAMPLE 2

Preparation of an Iron Complex, Pillared Bentonite, Trimethylaluminum Catalyst Composition and Ethylene Polymerization Using the Same

This Example provides a general preparative method that is generally applicable and adaptable to other transition metal compounds, pillared clays, and organometal cocatalysts of this invention.

Table 1 compares the data for the clay-supported catalyst prepared using the iron complex Fe(N³Py)(hfacac)₂ with trimethylaluminum (TMA) cocatalyst, both in the presence and absence of hydrogen. All polymerization runs shown in Table 1 were carried out using the method described in this Example, typically using 7 to 12 mg of Fe(N³Py)(hfacac)₂ in a 2 liter autoclave at 60° C., in the presence of typically 660 ppm TMA in isobutane at an ethylene pressure of 550 psig.

The amount of Fe(N³Py)(hfacac)₂ that was combined with the pillared bentonite support in the Fe(N³Py)(hfacac)₂/bentonite/TMA/H₂ catalyst system, was typically from about 1 wt % to about 10 wt %, based on the combined weight of the iron compound and the clay support. However, the amounts of Fe(N³Py)(hfacac)₂ can vary outside this range and still provide good catalytic activity.

The iron catalysts reported in Table 1 were prepared in situ in the high-pressure reactor used for the polymerization runs, by the following procedure. A jacketed, 2-liter bench scale autoclave was thoroughly purged with dry nitrogen followed by isobutane (bp −12° C.), while the reactor was heated to 60° C. When the reactor reached 60° C., a 0.0073-g sample of [N,N′-(2,6-diisopropylphenyl)-2,6-pyridinacetyldiimine]iron(II)bis(1,1,1,5,5,5-hexafluoro-2,4-acetylacetonate) (abbreviated Fe(N³Py)(hfacac)₂), followed by a 0.156 g sample of Al(III) pillared Bentonite (previously dried at 300° C. under nitrogen) were added directly to the reactor. In Runs 101 and 102, 0.22 and 0.166 g sample, respectively of solid MAO (Witco Corporation) was added directly to the reactor in place of Bentonite. For runs in which hydrogen was used, H₂ was introduced after the solids had been added to the reactor. Following these additions, 0.6 liter of isobutane was added, followed by 3 mL of a 2 Molar solution of AlMe₃ (TMA) in n-heptane solution, for a final TMA concentration of 660 ppm, along with an additional 0.6 L of isobutane. For Runs 110 and 111, 5.0 mL of 1.7 Molar solution MAO were added in place of the TMA solution. The reactor was then brought to a pressure of 550 psig with ethylene, as the polymerization ensued. Polymerization times were measured from T₀ commencing when the introduction of ethylene initiated, rather than when a pressure of 550 psig was attained. The polymerization runs were considered complete when ethylene was no longer consumed by the reaction mixture, thus when ethylene flow diminished to zero.

These data, especially Runs 102, 111 and 121, demonstrate that the iron catalyst in the presence of the aluminum pillared bentonite, TMA, and hydrogen, provides a more active catalyst (g polymer/g catalyst/hr) than the same iron catalyst in the presence of either the solid methylaluminoxane (MAO) treated with TMA (MAO/TMA) or solution MAO under similar conditions, which heretofore have been the cocatalysts of choice. The presence of hydrogen is also observed to enhance in the activity of this pillared bentonite catalyst composition.

### EXAMPLE 3

Preparation of a Nickel Complex, Pillared Bentonite, Trimethylaluminum Catalyst Composition and Ethylene Polymerization Using the Same

This Example also provides a general preparative method that can be applicable and adaptable to other transition metal compounds, pillared clays, and organometal cocatalysts of this invention.

Table 2 compares the data for the clay-supported catalyst prepared using the nickel complex Ni(N³Py)(hfacac)₂ with trimethylaluminum (TMA) cocatalyst, in the absence of hydrogen. Table 2 also provides comparative data for a wide range of support/cocatalyst/metal alkyl combinations, including the use of supports such as solid MAO, fluorided chlorided alumina, Ketjen RB, AlPO, and the like. In each case that data are presented for solid supports in Table 2, the support was treated with TMA. Generally, polymerization runs shown in Table 2 were carried out using the method described in this Example, using Ni(N³Py)(hfacac)₂ in a 2 liter autoclave at 60° C., in the presence of 1.2 liters of isobutane at an ethylene pressure of 550 psig.

The amount of Ni(N³Py)(hfacac)₂ that was combined with the bentonite support in the Ni(N³Py)(hfacac)₂/bentonite/TMA catalyst system, was typically from about 10 wt % to about 50 wt %, based on the combined weight of the iron compound and the clay support. This invention also performs well when this amount of Ni(N³Py)(hfacac)₂ varies outside this range.

The nickel catalysts reported in Table 2 were prepared in situ in the high-pressure reactor used for the polymerization runs, using a procedure analogous to that described in Example 2. Thus, a jacketed, 2-liter bench scale autoclave was thoroughly purged with dry nitrogen followed by isobutane (bp −12° C.), while the reactor was heated to 60° C. When the reactor reached 60° C., a 0.0562 g sample of [N,N′(2,6-diisopropylphenyl)-2,6-pyridinacetyldiimine]nickel(II)bis-(1,1,1,5,5,5-hexafluoro-2,4-acetylacetonate) (abbreviated Ni(N³Py)(hfacac)₂), followed by a 0.1238 g sample of the support listed in Table 2 were added directly to the reactor. Following these additions, 0.6 liter of isobutane was added, followed by the amount of 2.0 Molar TMA solution indicated in Table 2, along with an additional 0.6 L of isobutane.

For all the support materials listed in Table 2, including solid MAO, fluorided chlorided alumina, Ketjen B alumina (previously dried at abut 400° C. to about 800° C.), AlPO (P/Al=about 0.8), AlPO (P/Al=about 0.4), and Bentonite, the amount of TMA cocatalyst shown in Table 2 was then added. For the run utilizing TMA-treated MAO obtained from Witco, no TMA was added to the reactor. The reactor was then brought to a pressure of 550 psig with ethylene, as the polymerization ensued. Polymerization times were measured from T₀ commencing when the introduction of ethylene initiated, rather than when a pressure of 550 psig was attained. The polymerization runs were considered complete when ethylene was no longer consumed by the reaction mixture, thus when ethylene flow diminished to zero.

These data demonstrate that the productivity of the nickel catalyst/pillared bentonite/TMA catalyst system, both in terms of g polymer/g catalyst, and in terms of g polymer/g support, is very high. Further, the data in Table 2 illustrate that the clay supports are more active (in terms of g polymer/g support) than other extant cocatalyst support systems, including the less economical silica/MAO catalyst that is currently used as the support/cocatalyst system of choice.

### EXAMPLE 4

Constructive Examples of Transition Metal Compound, Pillared Clay, Organometal Cocatalyst Compositions for Use In Ethylene Polymerization Reactions

This Example, including Table 3, provides several constructive examples of individual catalyst components that can be used in preparing the catalyst composition and polymerization methods of this present invention. These constructive examples are presented in terms of the individual catalyst components, which can be used according to the techniques and methods presented herein.

The ligands, transition metal complexes, and catalyst compositions provided in Table 3 can be prepared according to the methods disclosed herein or by methods analogous to those disclosed herein. The quinoline-2-carboxaldimine ligand C of Table 3 can be prepared as disclosed for the analogous pyridine-2-carboxaldimine compounds in U.S. Pat. Nos. 6,150,295 and 6,399,725, each of which is incorporated herein by reference in its entirety.

Further, the catalyst compositions presented in Table 3 should be applicable and adaptable to other combinations of transition metal compounds, pillared clays, and organometal cocatalysts of this invention. Thus, these compositions should not be construed in any way as imposing limitations upon the scope of the present invention and the claims. On the contrary, it is to be clearly understood that resort can be had to various other embodiments, modifications, and equivalents thereof which can suggest themselves to one of ordinary skill in the art without departing from the spirit of the present invention or the scope of the appended claims.

TABLE 1
Fe(N³Py)(hfacac)₂/bentonite/TMA/H₂ catalyst system.

| | | | | | | | Produc- | | | | | | |
|---|---|---|---|---|---|---|---|---|---|---|---|---|---|
| | | | | | Reac- | | tivity | | | Activity | MI | HLMI | |
| | Iron | Support/ | Sup- | | tor | Hydro- | (gPoly- | Activity | Productivity | (gPolymer/ | (gm/ | (gm/ | Den- |
| Polymer | Catalyst | Co- | port | TMA | Temp. | gen | mer/ | (gPolymer/ | (gPolymer/ | g support/ | 10 | 10 | sity |
| Number | mmol | Catalyst | gm | mmol | ° C. | (moles) | gcat) | gcat/hr) | g support) | hr) | min) | min) | (g/cc) |
| Run 101 | 0.0100 | MAO (Witco) | 0.22 | 2 | 60 | 0.0 | 1880 | 5920 | 80 | 260 | 0.0 | 0.006 | 0.949 |
| Run 102 | 0.0130 | MAO(Witco) | 0.166 | 6 | 60 | 0.2 | 153 | 707 | 11 | 53 | | I.S. | |
| Run 110 | 0.0061 | Solution | | | 80 | 0.0 | 3670 | 36700 | No support | No support | 0.0 | 3.9 | 0.970 |
| | | MAO (5.0 | | | | | | | | | | | |
| | | ml) | | | | | | | | | | | |
| Run 111 | 0.0136 | Solution | | | 80 | 0.2 | 20460 | 42300 | No support | No support | 0.98 | 29.8 | 0.960 |
| | | MAO (5.0 | | | | | | | | | | | |
| | | ml) | | | | | | | | | | | |
| Run 120 | 0.0077 | Pillared | 0.156 | 6 | 60 | 0.0 | 1640 | 8970 | 80 | 420 | 0.0 | 0.33 | 0.955 |
| | | Bentonite | | | | | | | | | | | |
| | | (dried at | | | | | | | | | | | |
| | | 300° C./ | | | | | | | | | | | |
| | | N₂) | | | | | | | | | | | |
| Run 121 | 0.0126 | Pillared | 0.152 | 6 | 60 | 0.2 | 16583 | 66300 | 1310 | 5250 | 0.033 | 1.89 | 0.956 |
| | | Bentonite | | | | | | | | | | | |
| | | (dried at | | | | | | | | | | | |
| | | 300° C./ | | | | | | | | | | | |
| | | N₂) | | | | | | | | | | | |
| Run 122 | 0.0105 | Pillared | 0.165 | 6 | 80 | 0.2 | 7040 | 19200 | 426 | 1163 | ND | ND | ND |
| | | Bentonite | | | | | | | | | | | |
| | | (dried at | | | | | | | | | | | |
| | | 300° C./ | | | | | | | | | | | |
| | | N₂) | | | | | | | | | | | |

TABLE 2
Ni(N³Py)(hfacac)₂/bentonite/TMA catalyst system

| | Ni | | Sup- | Metal | Productivity | Productivity | Productivity | Productivity | HLMI | |
|---|---|---|---|---|---|---|---|---|---|---|
| Polymer | Catalyst | | port | Alkyl | (g Polym/g | (g Polym/g | (g Polym/g | (g Polym/g | (g/10 | Density |
| Number | (mmole) | Support | (g) | (mmole) | cat) | cat/hr) | support) | support/hr) | min) ^{§} | (g/cc) |
| Run 200 | | None | | TMA | 0 | | 0 | | | |
| Run 201 | | MAO (Witco) | | TMA | 12100 | | 1008 | | 0 | 0.895 |
| Run 202 | | MAO (Davison) | | TMA | 14010 | | 531 | | ND | 0.896 |
| Run 203 | | TMA treated MAO (Witco) | | | 5950 | | 314 | | ND | ND |
| Run 209 | | ZnCl₂ on Alumina | | TMA | 2137 | | 170 | | 0.04 | 0.889 |
| Run 210 | | Fluorided, chlorided | | TMA | 3333 | | 66 | | | |
| | | alumina | | | | | | | | |
| Run 211 | | Ketjen B (dried at | | TEA | 3775 | | 46 | | ND | ND |
| | | 800° C.) | | | | | | | | |
| Run 212 | | AlPO₄ (P/Al = 0.8) | | TMA | 4212 | | 328 | | 0.016 | 0.894 |
| Run 213 | | AlPO₄ (P/Al = 0.4) | | TMA | 3657 | | 285 | | 0.02 | 0.894 |
| Run 220 | | Aluminum Pillared | 0.12 | TMA | 264444 | 8372 | 1200 | 3801 | 0 | 0.898 |
| | | Bentonite | | (6.0) | | | | | | |
| | | (dried at 300° C./N₂) | | | | | | | | |
| Run 221 | 0.087 | Aluminum Pillared | 0.15 | TMA | 2237 | 5368 | 1133 | 2720 | 0 | 0.892 |
| | | Bentonite | | (1.0) | | | | | | |
| | | (dried at 300° C./N₂) | | | | | | | | |
| Run 222 | 0.102 | Iron (III) Exchanged | 0.21 | TMA | 2433 | 4866 | 1038 | 2076 | ND | ND |
| | | Bentonite (325) | | (1.0) | | | | | | |
| Run 223 | 0.098 | Silver (I) Exchanged | 0.31 | TMA | 1066 | 2132 | 656 | 1312 | ND | ND |
| | | Bentonite (325) | | (1.0) | | | | | | |
| Run 224 | 0.091 | Zinc (II) Exchanged | 0.19 | TMA | 1388 | 2775 | 578 | 1156 | ND | ND |
| | | Bentonite (325) | | (1.0) | | | | | | |
| Run 225 | 0.083 | Aluminum (III) | 0.31 | TMA | 2086 | 3447 | 487 | 561 | ND | ND |
| | | Exchanged Bentonite | | (1.0) | | | | | | |
| | | (325) | | | | | | | | |
| Run 226 | 0.070 | Aluminum Pillared | 0.17 | TMA | 1852 | 3705 | 683 | 1366 | ND | ND |
| | | Beidellite (dried at | | (1.0) | | | | | | |
| | | 300° C./N₂) | | | | | | | | |

^{§} ND = not determined

TABLE 3
Constructive Examples of Transition Metal Compound, Pillared Clay,
Organometal Cocatalyst Compositions for Use In Ethylene
Polymerization Reactions

| Example | Transition Metal | Organometal | | Optional Catalyst |
|---|---|---|---|---|
| No. | Compound§ | Cocatalyst | Activator-Support | Components |
| 4.1 | Fe(A)(hfacac)₂ | TMA | Aluminum pillared | aluminoxane, organoboron cmpd, |
| | 0.01 mmol | 6.0 mmol | bentonite, 0.21 g | organozinc cmpd, ionizing ionic cmpd |
| 4.2 | Ni(B)(hfacac)₂ | TMA | Aluminum exchanged | aluminoxane, organoboron cmpd, |
| | 0.1 mmol | 1.0 mmol | Bentonite, 0.31 g | organozinc cmpd, ionizing ionic cmpd |
| 4.3 | Ni(B)(hfacac)₂ | TMA | Aluminum pillared | aluminoxane, organoboron cmpd, |
| | 0.1 mmol | 1.0 mmol | bentonite, 0.17 g | organozinc cmpd, ionizing ionic cmpd |
| 4.4 | Ni(B)(hfacac)₂ | TMA | Aluminum pillared | aluminoxane, organoboron cmpd, |
| | 0.1 mmol | 1.8 mmol | bentonite, 0.15 g | organozinc cmpd, ionizing ionic cmpd |
| 4.5 | Ni(B)(hfacac)₂ | TMA | Silver exchanged | aluminoxane, organoboron cmpd, |
| | 0.1 mmol | 1.0 mmol | bentonite, 0.14 g | organozinc cmpd, ionizing ionic cmpd |
| 4.6 | Ni(B)(hfacac)₂ | TMA | H₃PO₄ treated, | aluminoxane, organoboron cmpd, |
| | 0.1 mmol | 1.0 mmol | aluminum pillared | organozinc cmpd, ionizing ionic cmpd |
| | | | bentonite, 0.15 g | |
| 4.7 | Ni(B)(hfacac)₂ | TMA | Iron exchanged | aluminoxane, organoboron cmpd, |
| | 0.1 mmol | 1.0 mmol | bentonite, 0.21 g | organozinc cmpd, ionizing ionic cmpd |
| 4.8 | Ni(B)(hfacac)₂ | TMA | Zinc exchanged | aluminoxane, organoboron cmpd, |
| | 0.1 mmol | 1.0 mmol | bentonite, 0.21 g | organozinc cmpd, ionizing ionic cmpd |
| 4.9 | Ni(B)(hfacac)₂ | TMA | Bentonite 0.38 g | aluminoxane, organoboron cmpd, |
| | 0.1 mmol | 1.0 mmol | | organozinc cmpd, ionizing ionic cmpd |
| 4.10 | Ni(B)(hfacac)₂ | TMA | Aluminum pillared | aluminoxane, organoboron cmpd, |
| | 0.1 mmol | 1.0 mmol | beidellite, 0.43 g | organozinc.cmpd, ionizing ionic cmpd |
| 4.11 | Ni(B)(hfacac)₂ | TMA | Aluminum exchanged, | aluminoxane, organoboron cmpd, |
| | 0.1 mmol | 1.0 mmol | aluminum pillared | organozinc cmpd, ionizing ionic cmpd |
| | | | beidellite, 0.15 g | |
| 4.12 | Ni(G)(hfacac)₂ | TMA | Aluminum pillared | aluminoxane, organoboron cmpd, |
| | 0.1 mmol | 1.0 mmol | beutonite, 0.2 g | organozinc cmpd, ionizing ionic cmpd |
| 4.13 | Ni(D)(hfacac)₂ | TMA | Beutonite, 0.43 g | aluminoxane, organoboron cmpd, |
| | 0.1 mmol | 2.0 mmol | | organozinc cmpd, ionizing ionic cmpd |
| 4.14 | Ni(D)(hfacac)₂ | TMA | Aluminum exchanged | aluminoxane, organoboron cmpd, |
| | 0.1 mmol | 1.0 mmol | beutonite, 0.14 g | organozinc cmpd, ionizing ionic cmpd |
| 4.15 | Ni(D)(hfacac)₂ | TMA | Aluminum pillared | aluminoxane, organoboron cmpd, |
| | 0.1 mmol | 1.0 mmol | beutonite, 0.11 g | organozinc cmpd, ionizing ionic cmpd |
| 4.16 | Ni(D)(hfacac)₂ | TMA | Iron exchanged | aluminoxane, organoboron cmpd, |
| | 0.1 mmol | 1.0 mmol | beutonite, 0.2 g | organozinc cmpd, ionizing ionic cmpd |
| 4.17 | Ni(D)(hfacac)₂ | TMA | Zinc exchanged | aluminoxane, organoboron cmpd, |
| | 0.1 mmol | 2.0 mmol | bentonite, 0.06 g | organozinc cmpd, ionizing ionic cmpd |

§Ligand abbreviations:

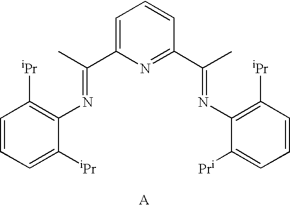

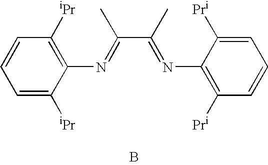

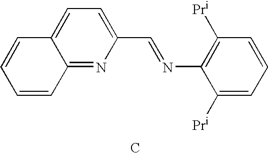

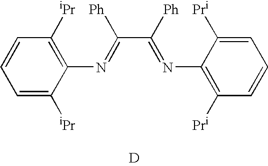

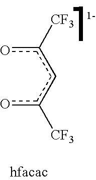

What is claimed is:

1. A catalyst composition comprising:
a) a transition metal compound in which the transition metal has a dⁿ electron configuration, wherein n is greater than or equal to 4 and less than or equal to 8;
b) a pillared clay; and
c) an organometal cocatalyst.

2. The catalyst composition of claim 1, wherein the catalyst composition further comprises hydrogen.

3. The catalyst composition of claim 1, wherein the transition metal is Cr, Mo, W, Mn, Re, Fe, Ru, Os, Co, Rh, Ir, Ni, Pd, or Pt.

4. The catalyst composition of claim 1, wherein the transition metal is Fe(II), Ni(II), or a combination thereof.

5. The catalyst composition of claim 1, wherein the transition metal compound comprises at least one ligand comprising an oxide, halide, nitride, ammonia, amine, amide, imide, carboxylate, acetylacetonate, dithiolate, carbonyl, cyanide, isocyanide, nitrile, peroxide, hydroxide, hydride, ether, diether, triether, carbonate, phosphate, nitrate, nitrite, sulfate, alkoxide, siloxide, thiolate, dithiolate disulfide, carbamate, dialkylcarbamate, pyridine, bipyridine, phenanthroline, terpyridine, diamine, triamine, diimine, pyridine diimine, pyrazolylborate, bis(pyrazolyl)borate, tris(pyrazolyl)borate, nitrosyl, thiocarbamate, diazabutadiene, dithiocarbamate, dialkylacetamide, dialkylformamide, formamidinate, phosphine, arsine, diphosphine, diarsine, oxalate, imidazole, pyrazolate, Schiff base, porphyrin, phthalocyanine, subphthalocyanine, picolinate, piperidine, pyrazolyl, salicylaldehyde, ethylenediamine, triflate, η²-alkene, η²-alkyne, η³-allyl, η⁴-diene, η⁵-pentadienyl, η⁶-arene, η⁷-heptatrienyl, η⁷-cycloheptatrienyl, η⁸-octatetraene, a substituted analog thereof, or a combination thereof, any one of which having up to about 20 carbon atoms.

6. The catalyst composition of claim 1, wherein the transition metal compound comprises at least one ligand of the formula: 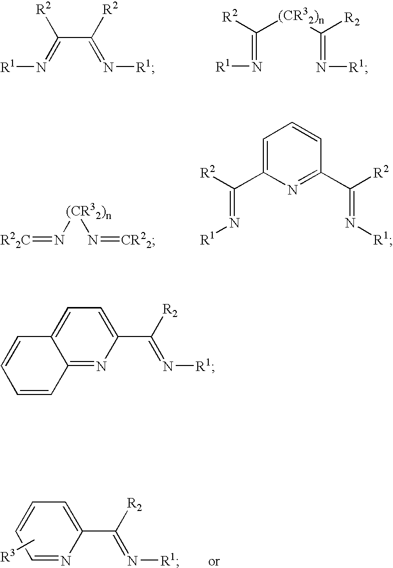
any combination thereof; wherein R¹, R², and R³ are, in each instance, independently a hydrocarbyl or a substituted hydrocarbyl having from 1 to about 20 carbon atoms; H; or halide; and wherein n is from 1 to about 5.

7. The catalyst composition of claim 1, wherein the transition metal compound comprises at least one ligand of the formula: 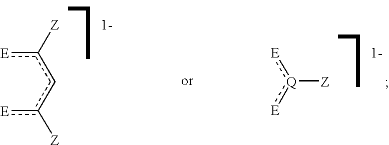
wherein E is independently O, S, NR, or CR₂; Q is independently C or S; and Z is independently OR, SR, NR₂, PR₂, R, SiR₃, or halide; wherein R in each instance is independently a hydrocarbyl or a substituted hydrocarbyl having from 1 to about 20 carbon atoms, or hydrogen.

8. The catalyst composition of claim 1, wherein the transition metal compound comprises a ligand with the following formula: 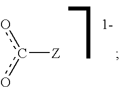
wherein Z is independently OR, SR, NR₂, PR₂, R, SiR₃, or halide; wherein R in each instance is independently a hydrocarbyl or a substituted hydrocarbyl having from 1 to about 20 carbon atoms, or hydrogen.

9. The catalyst composition of claim 1, wherein the transition metal is Cr, Mn, Fe, Co, or Ni; and the transition metal compound comprises a ligand with the following formula: 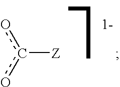
Z is independently OR, SR, NR₂, PR₂, R, SiR₃, or halide; wherein R in each instance is independently a hydrocarbyl or a substituted hydrocarbyl having from 1 to about 20 carbon atoms, or hydrogen.

10. The catalyst composition of claim 1, wherein the transition metal compound comprises a ligand of the formula: 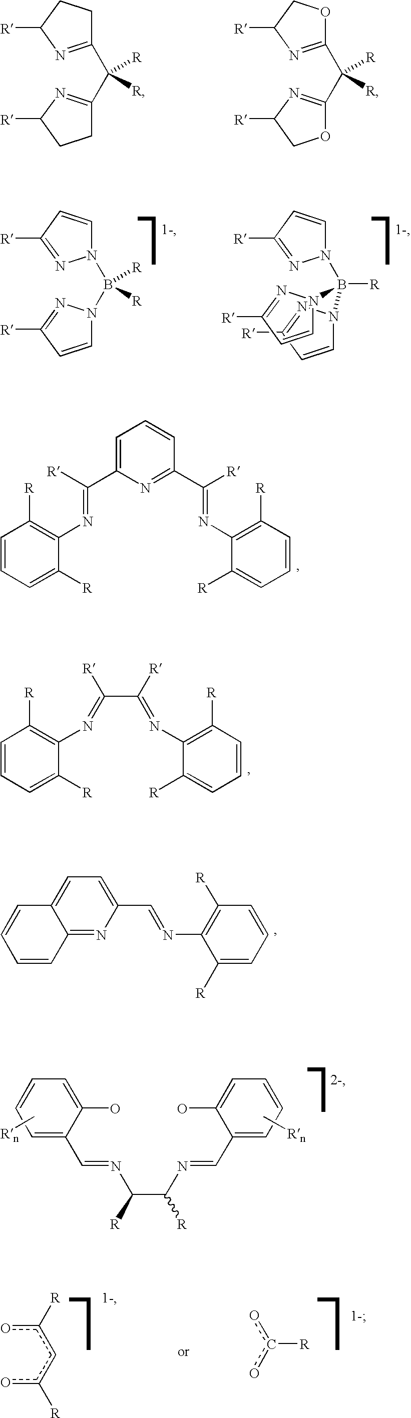
wherein R and R′ are independently aryl, alkyl, cycloalkyl, alkenyl, cycloalkenyl, cycloalkadienyl, alkynyl, aralkyl, aralkenyl, or aralkynyl, or a substituted derivative thereof, any one of which having from 1 to about 20 carbon atoms; halide; or hydrogen.

11. The catalyst composition of claim 1, wherein the transition metal compound comprises [2,6-(RN═CR′)₂C₅H₃N]M(η²-OCRCHCRO)₂, wherein M is Ni or Fe, and wherein R and R′ are independently aryl, alkyl, cycloalkyl, alkenyl, cycloalkenyl, cycloalkadienyl, alkynyl, aralkyl, aralkenyl, aralkynyl, a branched analog thereof, a substituted analog thereof, a heteroatom-substituted analog thereof, a halide-substituted analog thereof, an alkoxide-substituted analog thereof, or an amide-substituted analog thereof, any one of which having from 1 to about 20 carbon atoms; halide; or hydrogen.

12. The catalyst composition of claim 1, wherein the pillared clay comprises a silicate compound, an aluminosilicate compound, or a combination thereof.

13. The catalyst composition of claim 1, wherein the pillared clay comprises an allophane, a smectite, a halloysite, a mixed-layer clay, a fibrous clay, a serpentine clay, a vermiculite, a mica, a fluoromica, a chlorite, an illite, a laponite, a saponite, or a combination thereof.

14. The catalyst composition of claim 1, wherein the organometal cocatalyst is an organoaluminum compound, an aluminoxane, an organoboron compound, an organozinc compound, or any combination thereof.

15. The catalyst composition of claim 1, further comprising silica, silica-alumina, alumina, titania, zirconia, magnesia, boria, fluorided alumina, silated alumina, sulfated alumina, thoria, aluminophosphate, aluminum phosphate, phosphated silica, phosphated alumina, silica-titania, coprecipitated silica/titania, fluorided/silated alumina, and combinations or mixtures thereof.

16. The catalyst composition of claim 1, wherein the transition metal compound comprises {2,6-[(2,6-i-Pr₂C₆H₃)N═CMe]₂C₅H₃N}M(η²-OCCF₃CHCCF₃O)₂ wherein M is Ni or Fe; the pillared clay comprises bentonite; and the organometal cocatalyst comprises trimethylaluminum.

17. A process for preparing a catalyst composition, comprising contacting a transition metal compound in which the transition metal has a dⁿ electron configuration, wherein n is greater than or equal to 4 and less than or equal to 8, a pillared clay, and an organometal cocatalyst.

18. The process of claim 17, further comprising contacting the transition metal, the pillared clay, and the organometal cocatalyst with hydrogen.

19. The process of claim 17, wherein the transition metal is Fe(II), Ni(II), or a combination thereof.

20. A process of polymerizing olefins in the presence of a catalyst composition, wherein the catalyst composition comprises a transition metal compound in which the transition metal has a dⁿ electron configuration, wherein n is greater than or equal to 4 and less than or equal to 8; a pillared clay; and an organometal cocatalyst, comprising contacting the catalyst composition with an olefin at a temperature, pressure, and for an amount of time sufficient to polymerize the olefin.

21. The process of claim 20, wherein the catalyst composition further comprises hydrogen.

22. The process of claim 20, wherein the contacting occurs in a loop reaction zone.

23. An article that comprises a polymer produced according to claim 20.
